(19) United States
(12) Patent Application Publication
(10) Pub. No.: US 2013/0177833 A1
(43) Pub. Date: Jul. 11, 2013

(54) MEMBRANE ELECTRODE ASSEMBLY AND FUEL CELLS WITH INCREASED PERFORMANCE

(71) Applicant: BASF SE, Ludwigshafen (DE)

(72) Inventors: Osamu Yamamoto, Mie (JP); Jun Kikuchi, Mie (JP); Tomoyuki Ono, Mie-Gun (JP); Atsuo Sounai, Mie (JP)

(73) Assignee: BASF SE, Ludwigshafen (DE)

(21) Appl. No.: 13/717,170

(22) Filed: Dec. 17, 2012

Related U.S. Application Data
(63) Continuation of application No. 13/508,205, now abandoned.

(30) Foreign Application Priority Data
Nov. 6, 2009 (EP) 09013926.2

(51) Int. Cl. H01M 8/10

(52) U.S. Cl. CPC H01M 8/1018
USPC 429/483; 524/606; 524/602

(57) ABSTRACT

The present invention relates to membrane electrode assemblies comprising (i) at least two electrochemically active electrodes, (ii) said electrodes being separated by at least one polymer electrolyte membrane or electrolyte matrices, (iii) said electrodes having a catalyst layer being in contact with the above-mentioned polymer electrolyte membrane or matrices, (iv) said catalyst layer at the cathode comprising a polymer comprising the recurring units of the general formula (I) as ionomeric material and fuel cells with increased performance.

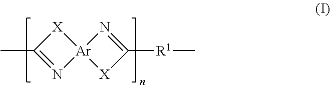

The present invention relates to membrane electrode assemblies and fuel cells with increased performance which comprise at least two electrochemically active electrodes which are separated by a polymer electrolyte membrane.

Polymer electrolyte membrane (PEM) fuel cells are already known. Currently, sulphonic acid-modified polymers are almost exclusively used in these fuel cells as proton-conducting membranes. Here, predominantly perfluorinated polymers are used. Nation™ from DuPont de Nemours, Willmington, USA is a prominent example of this. For the conduction of protons, a relatively high water content is required in the membrane, which typically amounts to 4-20 molecules of water per sulphonic acid group. The required water content, but also the stability of the polymer in connection with acidic water and the reaction gases hydrogen and oxygen, usually restricts the operating temperature of the PEM fuel cell stacks to 80-100° C. When applying pressure, the operating temperatures can be increased to >120° C. Otherwise, higher operating temperatures can not be realised without a loss of power in the fuel cell.

Due to system-specific reasons, however, operating temperatures in the fuel cell of more than 100° C. are desirable. The activity of the catalysts based on noble metals and contained in the membrane electrode assembly (MEA) is significantly improved at high operating temperatures. When the so-called reformates from hydrocarbons are used, the reformer gas in particular contains considerable amounts of carbon monoxide which usually have to be removed by means of an elaborate gas conditioning or gas purification process. The tolerance of the catalysts to the CO impurities is increased at high operating temperatures.

Furthermore, heat is produced during operation of fuel cells. However, the cooling of these systems to less than 80° C. can be very complex. Depending on the power output, the cooling devices can be constructed significantly less complex. This means that the waste heat in fuel cell systems that are operated at temperatures of more than 100° C. can be utilised distinctly better and therefore the efficiency of the fuel cell system via combined power and heat generation can be increased.

To achieve these temperatures, in general, membranes with new conductivity mechanisms are used. One approach to this end is the use of membranes which show electrical conductivity without employing water. The first promising development in this direction is set forth in document WO 96/13872.

As the tappable voltage of an individual fuel cell is relatively low, in general, several membrane electrode assemblies are connected in series and connected to each other via planar separator plates (bipolar plates).

However, in practice, the current available membrane electrode assemblies need to be further improved in order to become a more competitive economical alternative. One of the improvements needed is to increase the performance of the membrane electrode assemblies with respect to oxygen reduction at the cathode of the membrane electrode assembly.

Therefore, the object of the present invention was to provide membrane electrode assemblies and fuel cells with a performance as high as possible at the cathode of the membrane electrode assembly were the oxygen reduction takes place.

In addition, the improved membrane electrode assemblies should preferably have the following properties:
The fuel cells should have a service life as long as possible.
It should be possible to employ the fuel cells at operating temperatures as high as possible, in particular above 100° C.
In operation, the individual cells should exhibit a constant or improved performance over a period, which should be as long as possible.
After a long operating time, the fuel cells should have an open circuit voltage as high as possible as well as a gas crossover as low as possible. Furthermore, it should be possible to operate them with a stoichiometry as low as possible.
The fuel cells should manage to do without additional humidification of the fuel gas, if possible.
The fuel cells should be able to withstand permanent or alternate pressure differences between anode and cathodes as good as possible.
In particular, the fuel cells should be robust to different operating conditions (T, p, geometry, etc.) to increase the general reliability as good as possible.
Furthermore, the fuel cells should have an improved temperature and corrosion resistance and a relatively low gas permeability, in particular at high temperatures. A decline of the mechanical stability and the structural integrity, in particular at high temperatures, should be avoided as good as possible.

These objects are solved by the instant invention.

The instant invention relates to a membrane electrode assembly comprising:
(i) at least two electrochemically active electrodes
(ii) said electrodes being separated by at least one polymer electrolyte membrane or electrolyte matrices,
(iii) said electrodes having a catalyst layer being in contact with the above-mentioned polymer electrolyte membrane or matrices,
(iv) said catalyst layer comprising at least one ionomeric material, characterized in that at least the catalyst layer being in contact with the cathode comprises a polymer comprising the recurring units of the general formula (I)

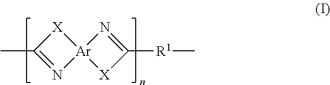

### Wherein (a)

Ar are identical or different and represent a tetracovalent aromatic group or tetracovalent heteroaromatic group, each can be monocyclic, bicyclic or polycyclic, and
X are identical or different and represent N, O, S and
R¹ are identical or different and represent a bicovalent group of the formula

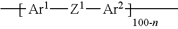

and,
Ar¹, Ar² are identical or different and represent a bicovalent aromatic group or bicovalent heteroaromatic group, each can be monocyclic, bicyclic or polycyclic, and,
Z¹ are identical or different and represent an bivalent alkyl group and/or an bivalent aromatic group, both in which at least one hydrogen atom is replaced by a fluorine atom, and
n is 0.1 to 99.9 mol-%,
   or (b)

Ar are identical or different and represent a tetracovalent group of the formula

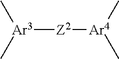

Ar³, Ar⁴ are identical or different and represent a tricovalent aromatic group or tricovalent-heteroaromatic group, each can be monocyclic, bicyclic or polycyclic, and,
Z² are identical or different and represent an bivalent alkyl group and/or an bivalent aromatic group, both in which at least one hydrogen atom is replaced by a fluorine atom, and
X are identical or different and represent N, O, S and
R¹ are identical or different and represent (i) a bicovalent group of the formula

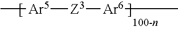

and,
Ar⁵, Ar⁶ are identical or different and represent a bicovalent aromatic group or bicovalent heteroaromatic group, each can be monocyclic, bicyclic or polycyclic, and,
Z³ are identical or different and represent N, O, S
or (ii) a bivalent alkyl group and/or an bivalent aromatic group, both of which can be further substituted,
and
n is 0.1 to 99.9 mol-%,
   as ionomeric material.

In both alternatives (a) or (b), it is preferred that n is between 40 to 60 mol-%, most preferred 50 mol-%, so that the ration between both subunits of the recurring units is comparable or equal.

In both alternatives (a) or (b), it is preferred that X stands for N or O. Most preferred in alternative (b) X stands for O.

Preferably, alkyl in Z¹ and/or Z², independent of each other, stand for short-chain bivalent alkyl groups having from 1 to 6 carbon atoms, such as, e.g., methyl, ethyl, n-propyl or i-propyl and n-, i-, or t-butyl, n-, i-, or t-pentane, n-, i-, or t-hexane.

Preferably, alkyl in Z¹ and/or Z², independent of each other, stand for short-chain bivalent alkyl groups having from 1 to 6 carbon atoms, such as, e.g., methyl, ethyl, n-propyl or i-propyl and n-, i-, or t-butyl, n-, i-, or t-pentane, n-, i-, or t-hexane, in which at least one carbon atom is perfluorinated or at least one carbon atom is substituted by at least one (CF₃)-group, most preferred by two (CF₃)-groups to form a —C(CF₃)₂— group.

Preferably, aromatic group in Z¹ and/or Z², independent of each other, stand for bivalent aromatic groups having 5 to 6 carbon atoms, in which one or more carbon atoms can be replaced by a heteroatom selected from N, O or S, in which at least one carbon atom is perfluorinated or at least one carbon atom is substituted by at least one (CF₃)-group, or an alkyl groups having from 2 to 6 carbon atoms which is substituted by at least one (CF₃)-group, most preferred by two (CF₃)-groups to form a —C(CF₃)₂— group or by a terminal —C(CF₃)₃ group.

Preferably, in alternative (b), R¹, independent of each other, stands for bivalent alkyl groups having from 1 to 10 carbon atoms, such as, e.g., methyl, ethyl, n-propyl or i-propyl and n-, i-, or t-butyl, n-, i-, or t-pentane, n-, i-, or t-hexane.

Preferably, in alternative (b), R¹, independent of each other, stand for bivalent aromatic groups having 5 to 6 carbon atoms, in which one or more carbon atoms can be replaced by a heteroatom selected from N, O or S.

Preferred bicovalent aromatic or bicovalent heteroaromatic groups Ar¹, Ar², Ar⁵, Ar⁶, independent of each other, stand for monocyclic, bicyclic, or polycyclic, either condensed or not, aromatic or heteroaromatic ring systems having 5 to 20 carbon atoms, in which one or more carbon atoms can be replaced by N, O, S. The bicovalent aromatic or bicovalent heteroaromatic groups Ar¹, Ar², Ar⁵, Ar⁶ can be substituted by further radicals.

Most preferred the bicovalent aromatic or bicovalent heteroaromatic groups Ar¹, Ar², Ar⁵, Ar⁶, independent of each other, are derived from benzene, naphthalene, biphenyl, diphenyl ether, diphenylmethane, diphenyldimethylmethane, bisphenone, diphenylsulphone, quinoline, pyridine, bipyridine, pyridazine, pyrimidine, pyrazine, triazine, tetrazine, pyrrole, pyrazole, anthracene, benzopyrrole, benzotriazole, benzooxathiadiazole, benzooxadiazole, benzopyridine, benzopyrazine, benzopyrazidine, benzopyrimidine, benzopyrazine, benzotriazine, indolizine, quinolizine, pyridopyridine, imidazopyrimidine, pyrazinopyrimidine, carbazole, aziridine, phenazine, benzoquinoline, phenoxazine, phenothiazine, acridizine, benzopteridine, phenanthroline and phenanthrene which optionally also can be substituted.

Preferred tricovalent aromatic or tricovalent heteroaromatic groups Ar³, Ar⁴, independent of each other, stand for monocyclic, bicyclic, polycyclic, condensed, aromatic or heteroaromatic ring systems having 5 to 20 carbon atoms, in which one or more carbon atoms can be replaced by N, O, S. The tricovalent aromatic or tricovalent heteroaromatic groups Ar³, Ar⁴, can be substituted by further radicals.

Most preferred the tricovalent aromatic or tricovalent heteroaromatic groups Ar³, Ar⁴, independent of each other, are derived from benzene, naphthalene, biphenyl, diphenyl ether, diphenylmethane, diphenyldimethylmethane, bisphenone, diphenylsulphone, quinoline, pyridine, bipyridine, pyridazine, pyrimidine, pyrazine, triazine, tetrazine, pyrrole, pyrazole, anthracene, benzopyrrole, benzotriazole, benzooxathiadiazole, benzooxadiazole, benzopyridine, benzopyrazine, benzopyrazidine, benzopyrimidine, benzopyrazine, benzotriazine, indolizine, quinolizine, pyridopyridine, imidazopyrimidine, pyrazinopyrimidine, carbazole, aziridine, phenazine, benzoquinoline, phenoxazine, phenothiazine, acridizine, benzopteridine, phenanthroline and phenanthrene which optionally also can be substituted.

Preferred tetracovalent aromatic or tetracovalent heteroaromatic groups Ar, independent of each other, stand for monocyclic, bicyclic, or polycyclic, either condensed or not, aromatic or heteroaromatic ring systems having 5 to 20 carbon atoms, in which one or more carbon atoms can be replaced by N, O, S. The tetracovalent aromatic or tetracovalent heteroaromatic groups Ar can be substituted by further radicals.

Most preferred the tetracovalent aromatic or tetracovalent heteroaromatic groups Ar, independent of each other, are derived from benzene, naphthalene, biphenyl, diphenyl ether, diphenylmethane, diphenyldimethylmethane, bisphenone, diphenylsulphone, quinoline, pyridine, bipyridine, pyridazine, pyrimidine, pyrazine, triazine, tetrazine, pyrrole, pyrazole, anthracene, benzopyrrole, benzotriazole, benzooxathiadiazole, benzooxadiazole, benzopyridine, benzopyrazine, benzopyrazidine, benzopyrimidine, benzopyrazine, benzotriazine, indolizine, quinolizine, pyridopyridine, imidazopyrimidine, pyrazinopyrimidine, carbazole, aziridine, phenazine, benzoquinoline, phenoxazine, phenothiazine, acridizine, benzopteridine, phenanthroline and phenanthrene which optionally also can be substituted.

In an preferred embodiment of the instant invention, the polymer comprising the recurring units of the general formula (I) has at least 10 recurring units of the general formula (I), more preferred at least 50 recurring units of the general formula (I).

Most preferred, the polymer comprising the recurring units of the general formula (I) has a weight averaged molecular weight Mw above 10000 (determined by Gel Permeation Chromatography).

Most preferred, the polymer comprising the recurring units of the general formula (I) has a number averaged molecular weight Mn above 5000.

Most preferred, the polymer comprising the recurring units of the general formula (I) has a solubility of at least 0.5% wt in DMAc at a temperature of 25° C.

It is preferred to have the ionomeric material according to the instant invention being present on the catalyst layer at the cathode in a certain ratio to the content of catalyst material. Typically, the content of catalyst, most typically noble metals, in the catalyst layer is 0.1 to 10.0 mg/cm², preferably 0.3 to 6.0 mg/cm² and particularly preferably 1 to 4.0 mg/cm². Therefore, it is preferred to have a weight ratio between ionomeric material and catalyst from 100:1 to 1:100, most preferred from 10:1 to 1:10. A specific preferred ratio is from 1:8 to 1:3. These amounts and ratio's also apply to catalyst layers in the anode, if desired.

The polymer comprising the recurring units of the general formula (I) can be produced by
A) mixing one or more aromatic di-, tri or tetramino compounds with one or more aromatic carboxylic acids or their esters, which contain at least two acid groups per carboxylic acid monomer, in which at least one of the di-, tri- or tetramino compounds or the aromatic carboxylic acids carries at least one Fluorine atom/is fluorinated or mixing one or more aromatic diamino-dihydroxy compounds with one or more aromatic carboxylic acids or their esters, which contain at least two acid groups per carboxylic acid monomer, in which at least one of the diamino-dihydroxy compounds or the aromatic carboxylic acids carries at least one Fluorine atom/is fluorinated or mixing one or more aromatic and/or heteroaromatic diaminocarboxylic acids, in which at least one of the diaminocarboxylic acid carries at least one
   Fluorine atom/is fluorinated,
   in polyphosphoric acid with formation of a solution and/or dispersion,
B) heating the mixture from step A) under inert gas to temperatures of up to 350° C., preferably up to 280° C., to form the polymer comprising the recurring units of the general formula (I).

The mixture obtained from step B) can be directly used to incorporated the polymer comprising the recurring units of the general formula (I) as ionomer in the catalyst layer, in particular in the catalyst layer being later in contact with the cathode.

In an alternative pathway, the mixture obtained from step B) can be first isolated by precipitating the polymer in a non-solvent, such as water or a media containing water, and, if required, drying. If such pathway is chosen, the polymer comprising the recurring units of the general formula (I) needs be dissolved in a solvent, such as DMAc, phosphoric acid or polyphosphoric acid, for incorporation as ionomer in the catalyst layer, in particular in the catalyst layer being later in contact with the cathode.

### Proton-Conducting Polymer Electrolyte Membranes and Matrices

Polymer electrolyte membranes and electrolyte matrices, respectively, suited for the purposes of the present invention are known per se.

In addition to the known polymer electrolyte membranes, electrolyte matrices are also suitable. Within the context of the present invention, the term “electrolyte matrices” is understood to mean—besides polymer electrolyte matrices—also other matrix materials in which an ion-conducting material or mixture is fixed or immobilised in a matrix. As an example, mention shall be made here of a matrix made of SiC and phosphoric acid.

In general, polymer electrolyte membranes comprising acids are used wherein the acids may be covalently bound to the polymers. Furthermore, a flat material may be doped with an acid in order to form a suitable membrane.

These doped membranes can, amongst other methods, be produced by swelling flat materials, for example a polymer film, with a fluid comprising acidic compounds, or by manufacturing a mixture of polymers and acidic compounds and subsequently forming a membrane by forming a flat structure and subsequent solidification in order to form a membrane.

Polymers suitable for this purpose include, amongst others, polyolefins, such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinyl amine, poly(N-vinyl acetamide), polyvinyl imidazole, polyvinyl carbazole, polyvinyl pyrrolidone, polyvinyl pyridine, polyvinyl chloride, polyvinylidene chloride, polytetrafluoroethylene, polyhexafluoropropylene, copolymers of PTFE with hexafluoropropylene, with perfluoropropylvinyl ether, with trifluoronitrosomethane, with carbalkoxyperfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular of norbornenes; polymers having C—O bonds in the backbone, for example polyacetal, polyoxymethylene, polyether, polypropylene oxide, polyepichlorohydrin, polytetrahydrofuran, polyphenylene oxide, polyether ketone, polyester, in particular polyhydroxyacetic acid, polyethyleneterephthalate, polybutyleneterephthalate, polyhydroxybenzoate, polyhydroxypropionic acid, polypivalolacton, polycaprolacton, polymalonic acid, polycarbonate; polymeric C—S-bonds in the backbone, for example polysulphide ether, polyphenylenesulphide, polysulphones, polyethersulphone; polymeric C—N bonds in the backbone, for example polyimines, polyisocyanides, polyetherimine, polyetherimides, polyaniline, polyaramides, polyamides, polyhydrazides, polyurethanes, polyimides, polyazoles, polyazole ether ketone, polyazines;

liquid crystalline polymers, in particular Vectra, as well as inorganic polymers, for example polysilanes, polycarbosilanes, polysiloxanes, polysilicic acid, polysilicates, silicones, polyphosphazenes and polythiazyl.

In this connection, alkaline polymers are preferred wherein this particularly applies to membranes doped with acids. Almost all known polymer membranes in which protons can be transported come into consideration as alkaline polymer membranes doped with acid. Here, acids are preferred which are able to transport protons without additional water, for example by means of the so-called “Grotthus mechanism”.

As alkaline polymer within the context of the present invention, preferably an alkaline polymer with at least one nitrogen atom in a repeating unit is used.

According to a preferred embodiment, the repeating unit in the alkaline polymer contains an aromatic ring with at least one nitrogen atom. The aromatic ring is preferably a five-membered or six-membered ring with one to three nitrogen atoms which may be fused to another ring, in particular another aromatic ring.

According to one particular aspect of the present invention, polymers stable at high temperatures are used which contain at least one nitrogen, oxygen and/or sulphur atom in one or in different repeating units.

Within the context of the present invention, stable at high temperatures means a polymer which, as a polymeric electrolyte, can be operated over the long term in a fuel cell at temperatures above 120° C. Over the long term means that a membrane according to the invention can be operated for at least 100 hours, preferably at least 500 hours, at a temperature of at least 80° C., preferably at least 120° C., particularly preferably at least 160° C., without the performance being decreased by more than 50%, based on the initial performance which can be measured according to the method described in WO 01/18894 A2.

The above mentioned polymers can be used individually or as a mixture (blend). Here, preference is given in particular to blends which contain polyazoles and/or polysulphones. In this context, the preferred blend components are polyethersulphone, polyether ketone and polymers modified with sulphonic acid groups, as described in WO 02/36249. By using blends, the mechanical properties can be improved and the material costs can be reduced.

Polyazoles constitute a particularly preferred group of alkaline polymers. An alkaline polymer based on polyazole contains recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII)

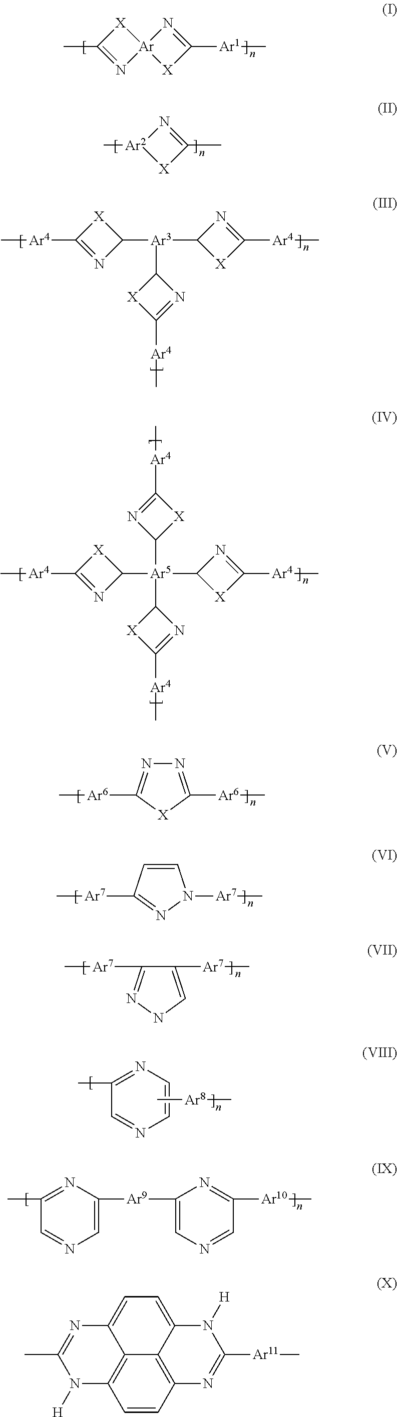

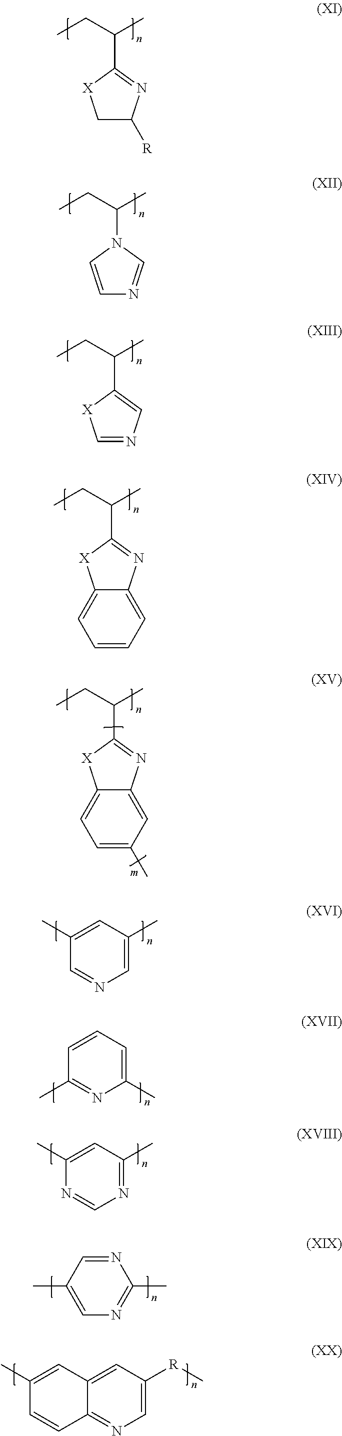

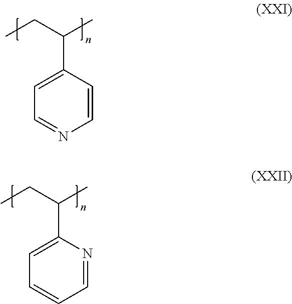

wherein
Ar are identical or different and represent a tetracovalent aromatic or heteroaromatic group which can be monocyclic or polycyclic,
Ar¹ are identical or different and represent a bicovalent aromatic or heteroaromatic group which can be monocyclic or polycyclic,
Ar² are identical or different and represent a bicovalent or tricovalent aromatic or heteroaromatic group which can be monocyclic or polycyclic,
Ar³ are identical or different and represent a tricovalent aromatic or heteroaromatic group which can be monocyclic or polycyclic,
Ar⁴ are identical or different and represent a tricovalent aromatic or heteroaromatic group which can be monocyclic or polycyclic,
Ar⁵ are identical or different and represent a tetracovalent aromatic or heteroaromatic group which can be monocyclic or polycyclic,
Ar⁶ are identical or different and represent a bicovalent aromatic or heteroaromatic group which can be monocyclic or polycyclic,
Ar⁷ are identical or different and represent a bicovalent aromatic or heteroaromatic group which can be monocyclic or polycyclic,
Ar⁸ are identical or different and represent a tricovalent aromatic or heteroaromatic group which can be monocyclic or polycyclic,
Ar⁹ are identical or different and represent a bicovalent or tricovalent or tetracovalent aromatic or heteroaromatic group which can be monocyclic or polycyclic,
Ar¹⁰ are identical or different and represent a bicovalent or tricovalent aromatic or heteroaromatic group which can be monocyclic or polycyclic,
Ar¹¹ are identical or different and represent a bicovalent aromatic or heteroaromatic group which can be monocyclic or polycyclic,
X are identical or different and represent oxygen, sulphur or an amino group which carries a hydrogen atom, a group having 1-20 carbon atoms, preferably a branched or unbranched alkyl or alkoxy group, or an aryl group as a further functional group,
R are identical or different and represent hydrogen, an alkyl group and an aromatic group, with the proviso that R in formula (XX) is not hydrogen, and
   n, m are each an integer greater than or equal to 10, preferably greater than or equal to 100.

Preferred aromatic or heteroaromatic groups are derived from benzene, naphthalene, biphenyl, diphenyl ether, diphenylmethane, diphenyldimethylmethane, bisphenone, diphenylsulphone, quinoline, pyridine, bipyridine, pyridazine, pyrimidine, pyrazine, triazine, tetrazine, pyrrole, pyrazole, anthracene, benzopyrrole, benzotriazole, benzooxathiadiazole, benzooxadiazole, benzopyridine, benzopyrazine, benzopyrazidine, benzopyrimidine, benzotriazine, indolizine, quinolizine, pyridopyridine, imidazopyrimidine, pyrazinopyrimidine, carbazole, aziridine, phenazine, benzoquinoline, phenoxazine, phenothiazine, acridizine, benzopteridine, phenanthroline and phenanthrene which optionally also can be substituted.

In this case, Ar¹, Ar⁴, Ar⁶, Ar⁷, Ar⁸, Ar⁹, Ar¹⁰, Ar¹¹ can have any substitution pattern, in the case of phenylene, for example, Ar¹, Ar⁴, Ar⁶, Ar⁷, Ar⁸, Ar⁹, Ar¹⁰, Ar¹¹ can be ortho-phenylene, meta-phenylene and para-phenylene. Particularly preferred groups are derived from benzene and biphenylene which may also be substituted.

Preferred alkyl groups are short-chain alkyl groups having from 1 to 4 carbon atoms, such as, e.g., methyl, ethyl, n-propyl or i-propyl and t-butyl groups.

Preferred aromatic groups are phenyl or naphthyl groups. The alkyl groups and the aromatic groups can be substituted.

Preferred substituents are halogen atoms, such as, e.g., fluorine, amino groups, hydroxy groups or short-chain alkyl groups, such as, e.g., methyl or ethyl groups.

Preference is given to polyazoles having recurring units of the formula (I) in which the functional groups X within a recurring unit are identical.

The polyazoles can in principle also have different recurring units wherein their functional groups X are different, for example. However, there are preferably only identical functional groups X in a recurring unit.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetrazapyrenes).

In another embodiment of the present invention, the polymer containing recurring azole units is a copolymer or a blend which contains at least two units of the formulae (I) to (XXII) which differ from one another. The polymers can be in the form of block copolymers (diblock, triblock), random copolymers, periodic copolymers and/or alternating polymers.

In a particularly preferred embodiment of the present invention, the polymer containing recurring azole units is a polyazole which only contains units of the formulae (I) and/or (II).

The number of recurring azole units in the polymer is preferably an integer greater than or equal to 10. Particularly preferred polymers contain at least 100 recurring azole units.

Within the scope of the present invention, polymers containing recurring benzimidazole units are preferred. Some examples of the most useful polymers containing recurring benzimidazole units are represented by the following formulae:

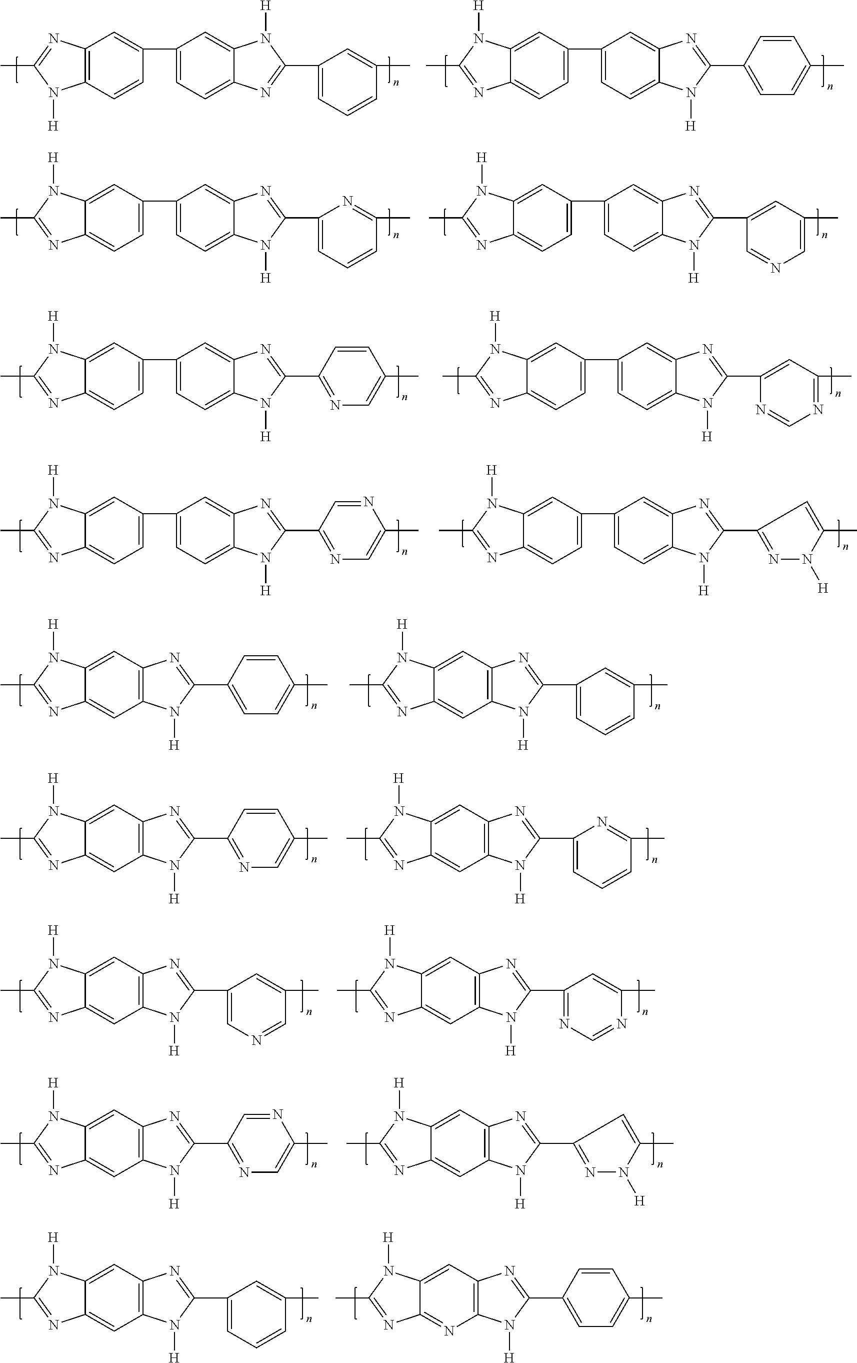

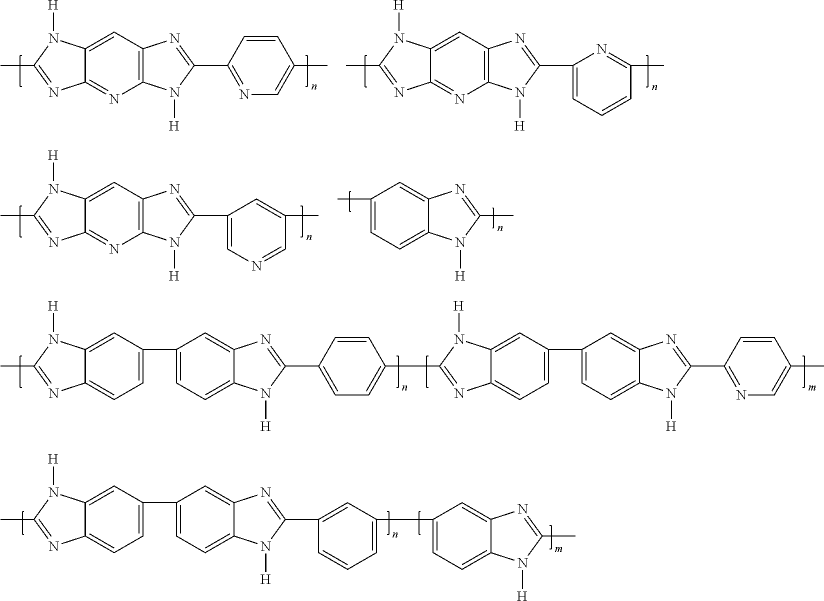

wherein n and m are each an integer greater than or equal to 10, preferably greater than or equal to 100.

The polyazoles used, in particular, however, the polybenzimidazoles are characterized by a high molecular weight. Measured as the intrinsic viscosity, this is preferably at least 0.2 dl/g, preferably 0.8 to 10 dl/g, in particular 1 to 10 dl/g.

The preparation of such polyazoles is known wherein one or more aromatic tetra-amino compounds are reacted in the melt with one or more aromatic carboxylic acids or the esters thereof, containing at least two acid groups per carboxylic acid monomer, to form a prepolymer. The resulting prepolymer solidifies in the reactor and is then comminuted mechanically. The pulverulent prepolymer is usually fully polymerised in a solid-state polymerisation at temperatures of up to 400° C.

The preferred aromatic carboxylic acids are, amongst others, dicarboxylic and tricarboxylic acids and tetracarboxylic acids or their esters or their anhydrides or their acid chlorides. The term aromatic carboxylic acids likewise also comprises heteroaromatic carboxylic acids.

Preferably, the aromatic dicarboxylic acids are isophthalic acid, terephthalic acid, phthalic acid, 5-hydroxyisophthalic acid, 4-hydroxyisophthalic acid, 2-hydroxyterephthalic acid, 5-aminoisophthalic acid, 5-N,N-dimethylaminoisophthalic acid, 5-N,N-diethylaminoisophthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 3-fluorophthalic acid, 5-fluoroisophthalic acid, 2-fluoroterephthalic acid, tetrafluorophthalic acid, tetrafluoroisophthalic acid, tetrafluoroterephthalic acid,1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether-4,4′-dicarboxylic acid, benzophenone-4,4′-dicarboxylic acid, diphenylsulphone-4,4′-dicarboxylic acid, biphenyl-4,4′-dicarboxylic acid, 4-trifluoromethylphthalic acid, 2,2-bis-(4-carboxyphenyl)hexafluoropropane, 4,4′-stilbenedicarboxylic acid, 4-carboxycinnamic acid or their C1-C20 alkyl esters or C5-C12 aryl esters or their acid anhydrides or their acid chlorides.

The aromatic tricarboxylic acids, tetracarboxylic acids or their C1-C20 alkyl esters or C5-C12 aryl esters or their acid anhydrides or their acid chlorides are preferably 1,3,5-benzenetricarboxylic acid (trimesic acid), 1,2,4-benzenetricarboxylic acid (trimellitic acid), (2-carboxyphenyl)iminodiacetic acid, 3,5,3′-biphenyltricarboxylic acid or 3,5,4′-biphenyltricarboxylic acid.

The aromatic tetracarboxylic acids or their C1-C20 alkyl esters or C5-C12 aryl esters or their acid anhydrides or their acid chlorides are preferably 3,5,3′,5′-biphenyltetracarboxylic acid, 1,2,4,5-benzenetetracarboxylic acid, benzophenonetetracarboxylic acid, 3,3′,4,4′-biphenyltetracarboxylic acid, 2,2′,3,3′-biphenyltetracarboxylic acid, 1,2,5,6-naphthalenetetracarboxylic acid or 1,4,5,8-naphthalenetetracarboxylic acid.

The heteroaromatic carboxylic acids used are preferably heteroaromatic dicarboxylic acids, tricarboxylic acids and tetracarboxylic acids or their esters or their anhydrides. Heteroaromatic carboxylic acids are understood to mean aromatic systems which contain at least one nitrogen, oxygen, sulphur or phosphorus atom in the aromatic group. These are preferably pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid, 2,4,6-pyridinetricarboxylic acid or benzimidazole-5,6-dicarboxylic acid and their C1-C20 alkyl esters or C5-C12 aryl esters or their acid anhydrides or their acid chlorides.

The content of tricarboxylic acids or tetracarboxylic acids (based on dicarboxylic acid used) is between 0 and 30 mol-%, preferably 0.1 and 20 mol-%, in particular 0.5 and 10 mol-%.

The aromatic and heteroaromatic diaminocarboxylic acids used are preferably diaminobenzoic acid or its monohydrochloride and dihydrochloride derivatives.

Preferably, mixtures of at least 2 different aromatic carboxylic acids are used. Particularly preferably, mixtures are used which also contain heteroaromatic carboxylic acids in addition to aromatic carboxylic acids. The mixing ratio of aromatic carboxylic acids to heteroaromatic carboxylic acids is between 1:99 and 99:1, preferably 1:50 to 50:1.

These mixtures are in particular mixtures of N-heteroaromatic dicarboxylic acids and aromatic dicarboxylic acids. Non-limiting examples of these are isophthalic acid, terephthalic acid, phthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid,1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether-4,4′-dicarboxylic acid, benzophenone-4,4′-dicarboxylic acid, diphenylsulphone-4,4′-dicarboxylic acid, biphenyl-4,4′-dicarboxylic acid, 4-trifluoromethylphthalic acid, pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid.

The preferred aromatic tetramino compounds include, amongst others, 3,3′,4,4′-tetraminobiphenyl, 2,3,5,6-tetraminopyridine, 1,2,4,5-tetraminobenzene, 3,3′,4,4′-tetraminodiphenyl sulphone, 3,3′,4,4′-tetraminodiphenyl ether, 3,3′,4,4′-tetraminobenzophenone, 3,3′,4,4′-tetraminodiphenylmethane and 3,3′,4,4′-tetraminodiphenyldimethylmethane as well as their salts, in particular their monohydrochloride, dihydrochloride, trihydrochloride and tetrahydrochloride derivatives.

Preferred polybenzimidazoles are commercially available under the trade name ®Celazole.

Preferred polymers include polysulphones, in particular polysulphone having aromatic and/or heteroaromatic groups in the backbone. According to a particular aspect of the present invention, preferred polysulphones and polyethersulphones have a melt volume rate MVR 300/21.6 of less than or equal to 40 cm³/10 min, in particular less than or equal to 30 cm³/10 min and particularly preferably less than or equal to 20 cm³/10 min, measured in accordance with ISO 1133. Here, preference is given to polysulphones with a Vicat softening temperature VST/A/50 of 180° C. to 230° C. In yet another preferred embodiment of the present invention, the number average of the molecular weight of the polysulphones is greater than 30,000 g/mol.

The polymers based on polysulphone include in particular polymers having recurring units with linking sulphone groups according to the general formulae A, B, C, D, E, F and/or G:

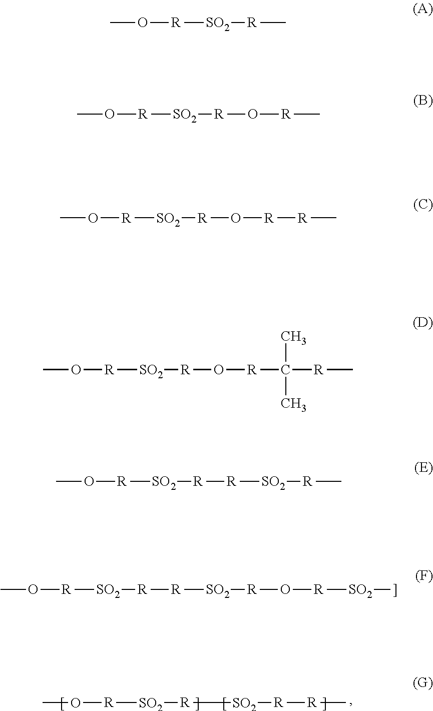

wherein the functional groups R, independently of another, are identical or different and represent aromatic or heteroaromatic groups, these functional groups having been explained in detail above. These include in particular 1,2-phenylene, 1,3-phenylene, 1,4-phenylene, 4,4′-biphenyl, pyridine, quinoline, naphthalene, phenanthrene.

The polysulphones preferred within the scope of the present invention include homopolymers and copolymers, for example random copolymers. Particularly preferred polysulphones comprise recurring units of the formulae H to N:

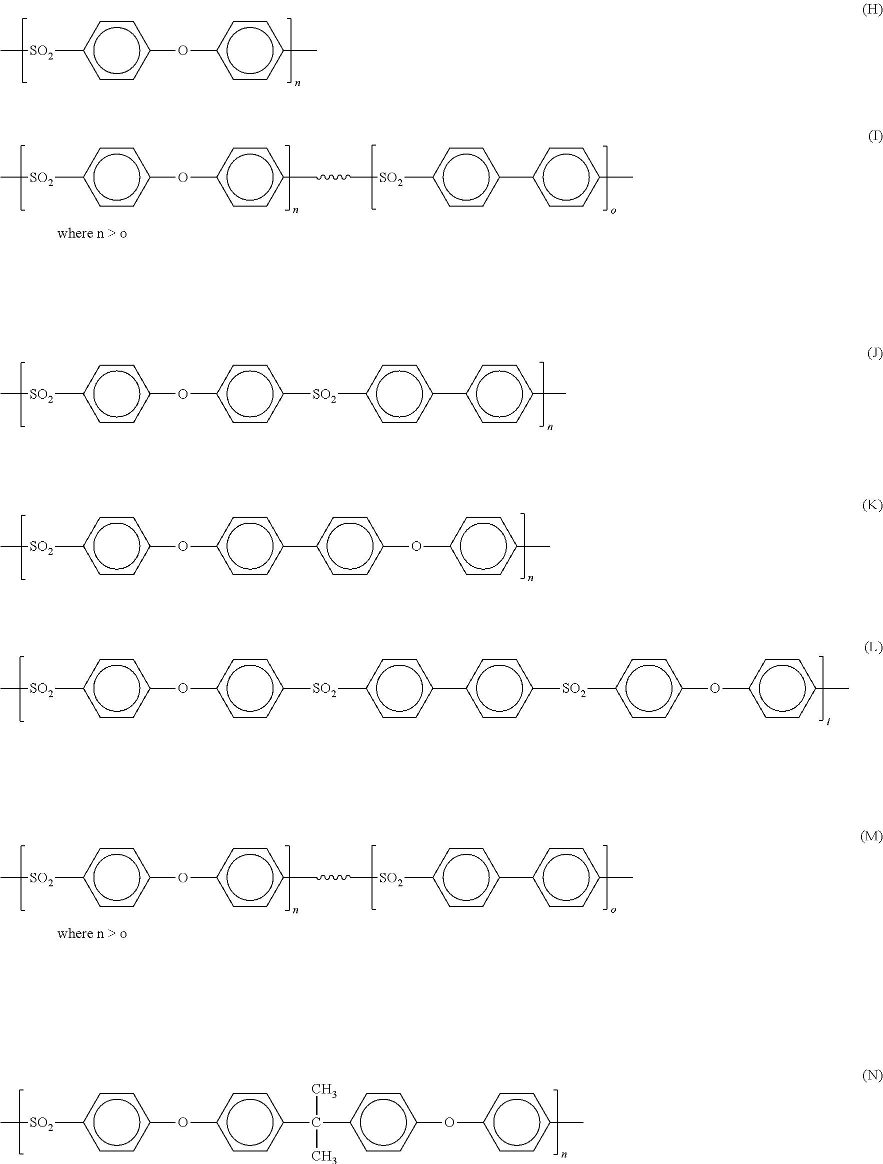

The previously described polysulphones can be obtained commercially under the trade names ®Victrex 200 P, ®Victrex 720 P,®Ultrason E,®Ultrason S,®Mindel, ®Radel A,®Radel R, ®Victrex HTA, ®Astrel and ®Udel.

Furthermore, polyether ketones, polyether ketone ketones, polyether ether ketones, polyether ether ketone ketones and polyaryl ketones are particularly preferred. These high-performance polymers are known per se and can be obtained commercially under the trade names Victrex® PEEK™, ®Hostatec, ®Kadel.

The polysulphones mentioned above and the polyether ketones, polyether ketone ketones, polyether ether ketones, polyether ether ketone ketones and polyaryl ketones mentioned can be, as already set forth, present as a blend component with alkaline polymers. Furthermore, the polysulphones mentioned above and the polyether ketones, polyether ketone ketones, polyether ether ketones, polyether ether ketone ketones and polyaryl ketones mentioned above can be used in sulphonated form as a polymer electrolyte wherein the sulphonated materials can also feature alkaline polymers, in particular polyazoles as a blend material. The embodiments shown and preferred with regard to the alkaline polymers or polyazoles also apply to these embodiments.

To produce polymer films, a polymer, preferably an alkaline polymer, in particular a polyazole can be dissolved in an additional step in polar, aprotic solvents such as dimethylacetamide (DMAc) and a film can be produced by means of classical methods.

In order to remove residues of solvents, the film thus obtained can be treated with a washing liquid, as is described in WO 02/07518. Due to the cleaning of the polyazole film to remove residues of solvent described patent application mentioned above, the mechanical properties of the film are surprisingly improved. These properties include in particular the E-modulus, the tear strength and the break strength of the film.

Additionally, the polymer film can have further modifications, for example by cross-linking, as described in WO 02/070592 or in WO 00/44816. In a preferred embodiment, the polymer film used consisting of an alkaline polymer and at least one blend component additionally contains a cross-linking agent, as described in WO 03/016384.

The thickness of the polyazole films can be within wide ranges. Preferably, the thickness of the polyazole film before its doping with acid is in the range of 5 μm to 2000 μm, particularly preferably in the range of 10 μm to 1000 μm; however, this should not constitute a limitation.

In order to achieve proton conductivity, these films are doped with an acid. In this context, acids include all known Lewis und Brønsted acids, preferably inorganic Lewis und Brønsted acids,

Furthermore, the use of polyacids is also possible, in particular isopolyacids and heteropolyacids as well as mixtures of different acids. Here, within the context of the invention, heteropolyacids define inorganic polyacids with at least two different central atoms, each formed of weak, polybasic oxygen acids of a metal (preferably Cr, MO, V, W) and a non-metal (preferably As, I, P, Se, Si, Te) as partial mixed anhydrides. These include, amongst others, the 12-phosphomolybdatic acid and the 12-phosphotungstic acid.

The conductivity of the polyazole film can be influenced via the degree of doping. The conductivity increases with an increasing concentration of the doping substance until a maximum value is reached. According to the invention, the degree of doping is given as mole of acid per mole of repeating unit of the polymer. Within the scope of the present invention, a degree of doping between 3 and 50, in particular between 5 and 40 is preferred.

Particularly preferred doping substances are sulphuric acid and phosphoric acid or compounds releasing these acids, for example during hydrolysis. A very particularly preferred doping substance is phosphoric acid (H₃PO₄). Here, highly concentrated acids are generally used. According to a particular aspect of the present invention, the concentration of the phosphoric acid is at least 50% by weight, in particular at least 80% by weight, based on the weight of the doping substance.

Furthermore, proton-conductive membranes can also be obtained by a method comprising the steps of
I) dissolving of polymers, particularly polyazoles in phosphoric acid,
II) heating the mixture obtainable in accordance with step A) under inert gas to temperatures of up to 400° C.,
III) forming a membrane using the solution of the polymer in accordance with step II) on a support and
IV) treating the membrane formed in step III) until it is self-supporting.

Furthermore, doped polyazole films can be obtained by a method comprising the steps of
A) mixing one or more aromatic tetramino compounds with one or more aromatic carboxylic acids or their esters, which contain at least two acid groups per carboxylic acid monomer, or mixing one or more aromatic and/or heteroaromatic diaminocarboxylic acids in polyphosphoric acid with formation of a solution and/or dispersion,
B) applying a layer using the mixture in accordance with step A) to a support or to an electrode,
C) heating the flat structure/layer obtainable in accordance with step B) under inert gas to temperatures of up to 350° C., preferably up to 280° C., with formation of the polyazole polymer,
D) treating the membrane formed in step C) (until it is self-supporting).

The aromatic or heteroaromatic carboxylic acid and tetramino compounds to be used in step A) have been described above.

The polyphosphoric acid used in step A) is a customary polyphosphoric acid as is available, for example, from Riedel-de Haen. The polyphosphoric acids Hₙ₊₂PₙO₃ₙ₊₁ (n>1) usually have a concentration of at least 83%, calculated as P₂O₅ (by acidimetry). Instead of a solution of the monomers, it is also possible to produce a dispersion/suspension.

The mixture produced in step A) has a weight ratio of polyphosphoric acid to the sum of all monomers of 1:10,000 to 10,000:1, preferably 1:1000 to 1000:1, in particular 1:100 to 100:1.

The layer formation in accordance with step B) is performed by means of measures known per se (pouring, spraying, application with a doctor blade) which are known from the prior art of polymer film production. Every support that is considered as inert under the conditions is suitable as a support. To adjust the viscosity, phosphoric acid (conc. phosphoric acid, 85%) can be added to the solution, where required. Thus, the viscosity can be adjusted to the desired value and the formation of the membrane be facilitated.

The layer produced in accordance with step B) has a thickness of 10 to 4000 μm, preferably 20 to 4000 μm, very preferably of 30 to 3500 μm, in particular of 50 to 3000 μm.

If the mixture in accordance with step A) also contains tricarboxylic acids or tetracarboxylic acid, branching/cross-linking of the formed polymer is achieved therewith. This contributes to an improvement in the mechanical property. The treatment of the polymer layer produced in accordance with step C) is performed in the presence of moisture at temperatures and for a sufficient period of time until the layer exhibits a sufficient strength for use in fuel cells. The treatment can be effected to the extent that the membrane is self-supporting so that it can be detached from the support without any damage.

In accordance with step C), the flat structure obtained in step B) is heated to a temperature of up to 350° C., preferably up to 280° C. and particularly preferably in the range of 200° C. to 250° C. The inert gases to be used in step C) are known to those in professional circles. These include in particular nitrogen as well as noble gases, such as neon, argon, helium.

In a variant of the method, the formation of oligomers and/or polymers can already be brought about by heating the mixture from step A) to temperatures of up to 350° C., preferably up to 280° C. Depending on the selected temperature and duration, it is then possible to dispense partly or fully with the heating in step C). This variant is also an object of the present invention.

The treatment of the membrane in step D) is performed at temperatures of more than 0° C. and less than 150° C., preferably at temperatures between 10° C. and 120° C., in particular between room temperature (20° C.) and 90° C., in the presence of moisture or water and/or steam and/or water-containing phosphoric acid of up to 85%. The treatment is preferably performed at normal pressure, but can also be carried out with action of pressure. It is essential that the treatment takes place in the presence of sufficient moisture whereby the polyphosphoric acid present contributes to the solidification of the membrane by means of partial hydrolysis with formation of low molecular weight polyphosphoric acid and/or phosphoric acid.

The hydrolysis fluid may be a solution wherein the fluid may also contain suspended and/or dispersed constituents. The viscosity of the hydrolysis fluid can be within wide ranges wherein an addition of solvents or an increase in temperature can take place to adjust the viscosity. The dynamic viscosity is preferably in the range of 0.1 to 10,000 mPa*s, in particular 0.2 to 2000 mPa*s, wherein these values can be measured in accordance with DIN 53015, for example.

The treatment in accordance with step D) can take place with any known method. The membrane obtained in step C) can, for example, be immersed in a fluid bath. Furthermore, the hydrolysis fluid can be sprayed onto the membrane. Additionally, the hydrolysis fluid can be poured onto the membrane. The latter methods have the advantage that the concentration of the acid in the hydrolysis fluid remains constant during the hydrolysis. However, the first method is often cheaper in practice.

The oxo acids of phosphorus and/or sulphur include in particular phosphinic acid, phosphonic acid, phosphoric acid, hypodiphosphonic acid, hypodiphosphoric acid, oligophosphoric acids, sulphurous acid, disulphurous acid and/or sulphuric acid. These acids can be used individually or as a mixture.

Furthermore, the oxo acids of phosphorus and/or sulphur comprise monomers that can be processed by free-radical polymerisation and comprise phosphonic acid and/or sulphonic acid groups.

Monomers comprising phosphonic acid groups are known in professional circles. These are compounds having at least one carbon-carbon double bond and at least one phosphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the scope of the present invention, the polymer comprising phosphonic acid groups results from the polymerisation product which is obtained by polymerising the monomer comprising phosphonic acid groups alone or with other monomers and/or cross-linking agents.

The monomer comprising phosphonic acid groups may comprise one, two, three or more carbon-carbon double bonds. Furthermore, the monomer comprising phosphonic acid groups may contain one, two, three or more phosphonic acid groups.

In general, the monomer comprising phosphonic acid groups contains 2 to 20, preferably 2 to 10 carbon atoms.

The monomer comprising phosphonic acid groups is preferably a compound of the formula

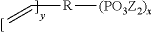

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned functional groups themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group wherein the above-mentioned functional groups themselves can be substituted with halogen, —OH, —CN, and
x represents an integer 1, 2, 3, 4, 5, 6, 7, 8, 9 or 10
y represents an integer 1, 2, 3, 4, 5, 6, 7, 8, 9 or 10,
   and/or of the formula

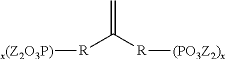

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned functional groups themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned functional groups themselves can be substituted with halogen, —OH, —CN, and
x represents an integer 1, 2, 3, 4, 5, 6, 7, 8, 9 or 10,
   and/or of the formula

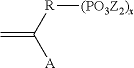

wherein
A represents a group of the formulae COOR², CN, CONR²₂, OR² and/or R²,
   wherein R² is hydrogen, a C1-C15 alkyl group, a C1-C15 alkoxy group, an ethyleneoxy group or a C5-C20 aryl or heteroaryl group, wherein the above-mentioned functional groups themselves can be substituted with halogen, —OH, COOZ, —CN, NZ₂.
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned functional groups themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned functional groups themselves can be substituted with halogen, —OH, —CN, and
x represents an integer 1, 2, 3, 4, 5, 6, 7, 8, 9 or 10.

Preferred monomers comprising phosphonic acid groups include, inter alia, alkenes which contain phosphonic acid groups, such as ethenephosphonic acid, propenephosphonic acid, butenephosphonic acid; acrylic acid compounds and/or methacrylic acid compounds which contain phosphonic acid groups, such as for example 2-phosphonomethylacrylic acid, 2-phosphonomethylmethacrylic acid, 2-phosphonomethylacrylamide and 2-phosphonomethylmethacrylamide.

Commercially available vinylphosphonic acid (ethenephosphonic acid), such as it is available from the companies Aldrich or Clariant GmbH, for example, is particularly preferably used. A preferred vinylphosphonic acid has a purity of more than 70%, in particular 90% and particularly preferably a purity of more than 97%.

The monomers comprising phosphonic acid groups can furthermore be used in the form of derivatives which can subsequently be converted to the acid, wherein the conversion to the acid may also take place in the polymerised state. These derivatives include in particular the salts, the esters, the amides and the halides of the monomers comprising phosphonic acid groups.

Furthermore, the monomers comprising phosphonic acid groups can also be introduced onto and into the membrane after the hydrolysis. This can be performed by means of measures known per se (e.g., spraying, immersing, etc.) which are known from the prior art.

According to a particular aspect of the present invention, the ratio of the weight of the sum of phosphoric acid, polyphosphoric acid and the hydrolysis products of the polyphosphoric acid to the weight of the monomers that can be processed by free-radical polymerisation, for example the monomers comprising phosphonic acid groups, is preferably greater than or equal to 1:2, in particular greater than or equal to 1:1 and particularly preferably greater than or equal to 2:1.

Preferably, the ratio of the weight of the sum of phosphoric acid, polyphosphoric acid and the hydrolysis products of the polyphosphoric acid to the weight of the monomers that can be processed by free-radical polymerisation is in the range of 1000:1 to 3:1, in particular 100:1 to 5:1 and particularly preferably 50:1 to 10:1.

This ratio can easily be determined by means of customary methods in which, in many cases, the phosphoric acid, polyphosphoric acid and their hydrolysis products can be washed out of the membrane. Through this, the weight of the polyphosphoric acid and its hydrolysis products can be obtained after the completed hydrolysis to phosphoric acid. In general, this also applies to the monomers which can be processed by free-radical polymerisation.

Monomers comprising sulphonic acid groups are known in professional circles. These are compounds having at least one carbon-carbon double bond and at least one sulphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the scope of the present invention, the polymer comprising sulphonic acid groups results from the polymerisation product which is obtained by polymerisation of the monomer comprising sulphonic acid groups alone or with further monomers and/or cross-linking agents.

The monomer comprising sulphonic acid groups may comprise one, two, three or more carbon-carbon double bonds. Furthermore, the monomer comprising sulphonic acid groups can contain one, two, three or more sulphonic acid groups.

In general, the monomer comprising sulphonic acid groups contains 2 to 20, preferably 2 to 10 carbon atoms.

The monomer comprising sulphonic acid groups is preferably a compound of the formula

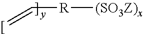

wherein
R represents a bond, a bicovalent C1-C15 alkylene group, a bicovalent C1-C15 alkyleneoxy group, for example ethyleneoxy group, or a bicovalent C5-C20 aryl or heteroaryl group, wherein the above-mentioned functional groups themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group wherein the above-mentioned functional groups themselves can be substituted with halogen, —OH, —CN, and
x represents an integer 1, 2, 3, 4, 5, 6, 7, 8, 9 or 10,
y represents an integer 1, 2, 3, 4, 5, 6, 7, 8, 9 or 10,
   and/or of the formula

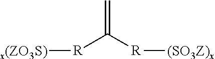

wherein
R represents a bond, a bicovalent C1-C15 alkylene group, a bicovalent C1-C15 alkyleneoxy group, for example ethyleneoxy group, or a bicovalent C5-C20 aryl or heteroaryl group, wherein the above-mentioned functional groups themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned functional groups themselves can be substituted with halogen, —OH, —CN, and
x represents an integer 1, 2, 3, 4, 5, 6, 7, 8, 9 or 10,
   and/or of the formula

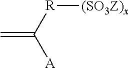

wherein
A represents a group of the formulae COOR², CN, CONR²₂, OR² and/or R²,
   wherein R² is hydrogen, a C1-C15 alkyl group, a C1-C15 alkoxy group, an ethyleneoxy group or a C5-C20 aryl or heteroaryl group, wherein the above-mentioned functional groups themselves can be substituted with halogen, —OH, COOZ, —CN, NZ₂,
R represents a bond, a bicovalent C1-C15 alkylene group, a bicovalent C1-C15 alkyleneoxy group, for example ethyleneoxy group, or a bicovalent C5-C20 aryl or heteroaryl group, wherein the above-mentioned functional groups themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned functional groups themselves can be substituted with halogen, —OH, —CN, and
x represents an integer 1, 2, 3, 4, 5, 6, 7, 8, 9 or 10.

Preferred monomers comprising sulphonic acid groups include, inter alia, alkenes which contain sulphonic acid groups, such as ethenesulphonic acid, propenesulphonic acid, butenesulphonic acid; acrylic acid compounds and/or methacrylic acid compounds which contain sulphonic acid groups, such as for example 2-sulphonomethylacrylic acid, 2-sulphonomethylmethacrylic acid, 2-sulphonomethylacrylamide and 2-sulphonomethylmethacrylamide.

Commercially available vinylsulphonic acid (ethenesulphonic acid), such as it is available from the companies Aldrich or Clariant GmbH, for example, is particularly preferably used. A preferred vinylsulphonic acid has a purity of more than 70%, in particular 90% and particularly preferably a purity of more than 97%.

The monomers comprising sulphonic acid groups can furthermore be used in the form of derivatives which can subsequently be converted to the acid, wherein the conversion to the acid may also take place in the polymerised state. These derivatives include in particular the salts, the esters, the amides and the halides of the monomers comprising sulphonic acid groups.

Furthermore, the monomers comprising sulphonic acid groups can also be introduced onto and into the membrane after the hydrolysis. This can be performed by means of measures known per se (e.g., spraying, immersing, etc.) which are known from the prior art.

In another embodiment of the invention, monomers capable of cross-linking can be used. These monomers can be added to the hydrolysis fluid. Furthermore, the monomers capable of cross-linking can also be applied to the membrane obtained after the hydrolysis.

The monomers capable of cross-linking are in particular compounds having at least 2 carbon-carbon double bonds. Preference is given to dienes, trienes, tetraenes, dimethylacrylates, trimethylacrylates, tetramethylacrylates, diacrylates, triacrylates, tetraacrylates.

Particular preference is given to dienes, trienes, tetraenes of the formula

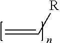

dimethylacrylates, trimethylacrylates, tetramethylacrylates of the formula

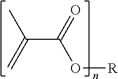

diacrylates, triacrylates, tetraacrylates of the formula

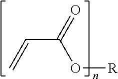

wherein
R represents a C1-C15 alkyl group, a C5-C20 aryl or heteroaryl group, NR′, —SO₂, PR′, Si(R′)₂, wherein the above-mentioned functional groups themselves can be substituted,
R′ represent, independently of another, hydrogen, a C1-C15 alkyl group, a C1-C15 alkoxy group, a C5-C20 aryl or heteroaryl group, and
n is at least 2.

The substituents of the above-mentioned functional group R are preferably halogen, hydroxyl, carboxy, carboxyl, carboxylester, nitriles, amines, silyl, siloxane groups.

Particularly preferred cross-linking agents are allyl methacrylate, ethylene glycol dimethacrylate, diethylene glycol dimethacrylate, triethylene glycol dimethacrylate, tetraethylene glycol dimethacrylate and polyethylene glycol dimethacrylate, 1,3-butanediol dimethacrylate, glycerol dimethacrylate, diurethane dimethacrylate, trimethylpropane trimethacrylate, epoxy acrylates, for example ebacryl, N′,N-methylenebisacrylamide, carbinol, butadiene, isoprene, chloroprene, divinylbenzene and/or bisphenol A dimethylacrylate. These compounds are commercially available from Sartomer Company Exton, Pennsylvania under the designations CN120, CN104 and CN980, for example.

The use of cross-linking agents is optional wherein these compounds can typically be used in the range of 0.05 to 30% by weight, preferably 0.1 to 20% by weight, particularly preferably 1 to 10% by weight, based on the weight of the membrane.

The cross-linking monomers can be introduced onto and into the membrane after the hydrolysis. This can be performed by means of measures known per se (e.g., spraying, immersing etc.) which are known from the prior art.

According to a particular aspect of the present invention, the monomers comprising phosphonic acid and/or sulphonic acid groups or the cross-linking monomers can be polymerised wherein the polymerisation is preferably a free-radical polymerisation. The formation of radicals can take place thermally, photochemically, chemically and/or electrochemically.

For example, a starter solution containing at least one substance capable of forming radicals can be added to the hydrolysis fluid. Furthermore, a starter solution can be applied to the membrane after the hydrolysis. This can be performed by means of measures known per se (e.g., spraying, immersing etc.) which are known from the prior art.

Suitable radical formers are, amongst others, azo compounds, peroxy compounds, persulphate compounds or azoamidines. Non-limiting examples are dibenzoyl peroxide, dicumene peroxide, cumene hydroperoxide, diisopropyl peroxydicarbonate, bis(4-t-butylcyclohexyl) peroxydicarbonate, dipotassium persulphate, ammonium peroxydisulphate, 2,2′-azobis(2-methylpropionitrile) (AIBN), 2,2′-azobis(isobutyric acid amidine)hydrochloride, benzopinacol, dibenzyl derivatives, methyl ethylene ketone peroxide, 1,1-azobiscyclohexanecarbonitrile, methyl ethyl ketone peroxide, acetyl acetone peroxide, dilauryl peroxide, didecanoyl peroxide, tert-butylper-2-ethyl hexanoate, ketone peroxide, methyl isobutyl ketone peroxide, cyclohexanone peroxide, dibenzoyl peroxide, tert-butylperoxybenzoate, tert-butylperoxyisopropylcarbonate, 2,5-bis(2-ethylhexanoylperoxy)-2,5-dimethylhexane, tert-butylperoxy-2-ethylhexanoate, tert.-butylperoxy-3,5,5-trimethylhexanoate, tert-butylperoxyisobutyrate, tert-butylperoxyacetate, dicumene peroxide, 1,1-bis(tert-butylperoxy)cyclohexane, 1,1-bis(tert-butylperoxy)-3,3,5-trimethylcyclohexane, cumyl hydroperoxide, tert-butylhydroperoxide, bis(4-tert-butylcyclohexyl) peroxydicarbonate, and the radical formers available from DuPont under the name ®Vazo, for example ®Vazo V50 and ®Vazo WS.

Furthermore, use may also be made of radical formers which form free radicals when exposed to radiation. Preferred compounds include, amongst others, α,α-diethoxyacetophenone (DEAP, Upjon Corp), n-butyl benzoin ether ®Trigonal-14, AKZO) and 2,2-dimethoxy-2-phenylacetophenone (®Igacure 651) and 1-benzoyl cyclohexanol (®Igacure 184), bis-(2,4,6-trimethylbenzoyl)phenylphosphine oxide (®Irgacure 819) and 1-[4-(2-hydroxyethoxy)phenyl]-2-hydroxy-2-phenylpropan-1-one (®Irgacure 2959), each of which are commercially available from the company Ciba Geigy Corp.

Typically, between 0.0001 and 5% by weight, in particular 0.01 to 3% by weight (based on the weight of the monomers that can be processed by free-radical polymerisation; monomers comprising phosphonic acid groups and/or sulphonic acid groups or the cross-linking monomers, respectively) of radical formers are added. The amount of radical formers can be varied according to the degree of polymerisation desired.

The polymerisation can also take place by action of IR or NIR (IR=infrared, i.e. light having a wavelength of more than 700 nm; NIR=near−IR, i.e. light having a wavelength in the range of about 700 to 2000 nm and an energy in the range of about 0.6 to 1.75 eV), respectively.

The polymerisation can also take place by action of UV light having a wavelength of less than 400 nm. This polymerisation method is known per se and described, for example, in Hans Joerg Elias, Makromolekulare Chemie, 5th edition, volume 1, pp. 492-511; D. R. Arnold, N.C. Baird, J. R. Bolton, J. C. D. Brand, P. W. M Jacobs, P. de Mayo, W. R. Ware, Photochemistry—An Introduction, Academic Press, New York and M. K. Mishra, Radical Photopolymerization of Vinyl Monomers, J. Macromol. Sci.-Revs. Macromol. Chem. Phys. C22 (1982-1983) 409.

The polymerisation may also take place by exposure to β rays, γ rays and/or electron rays. According to a particular embodiment of the present invention, a membrane is irradiated with a radiation dose in the range of 1 to 300 kGy, preferably 3 to 200 kGy and very particularly preferably 20 to 100 kGy.

The polymerisation of the monomers comprising phosphonic acid groups and/or sulphonic acid groups or the cross-linking monomers, respectively, preferably takes place at temperatures of more than room temperature (20° C.) and less than 200° C., in particular at temperatures between 40° C. and 150° C., particularly preferably between 50° C. and 120° C. The polymerisation is preferably performed at normal pressure, but can also be carried out with action of pressure. The polymerisation leads to a solidification of the flat structure, wherein this solidification can be observed via measuring the microhardness. Preferably, the increase in hardness caused by the polymerisation is at least 20%, based on the hardness of a correspondingly hydrolysed membrane without polymerisation of the monomers.

According to a particular aspect of the present invention, the molar ratio of the molar sum of phosphoric acid, polyphosphoric acid and the hydrolysis products of polyphosphoric acid to the number of moles of the phosphonic acid groups and/or sulphonic acid groups in the polymers obtainable by polymerisation of monomers comprising phosphonic acid groups and/or monomers comprising sulphonic acid groups is preferably greater than or equal to 1:2, in particular greater than or equal to 1:1 and particularly preferably greater than or equal to 2:1.

Preferably, the molar ratio of the molar sum of phosphoric acid, polyphosphoric acid and the hydrolysis products of polyphosphoric acid to the number of moles of the phosphonic acid groups and/or sulphonic acid groups in the polymers obtainable by polymerisation of monomers comprising phosphonic acid groups and/or monomers comprising sulphonic acid groups lies in the range of 1000:1 to 3:1, in particular 100:1 to 5:1 and particularly preferably 50:1 to 10:1.

The molar ratio can be determined by means of customary methods. To this end, especially spectroscopic methods, for example, NMR spectroscopy can be used. In this connection, it has to be considered that the phosphonic acid groups are present in the formal oxidation stage 3 and the phosphorus in phosphoric acid, polyphosphoric acid or hydrolysis products thereof, respectively, in oxidation stage 5.

Depending on the degree of polymerisation desired, the flat structure which is obtained after polymerisation is a self-supporting membrane. Preferably, the degree of polymerisation is at least 2, in particular at least 5, particularly preferably at least 30 repeating units, in particular at least 50 repeating units, very particularly preferably at least 100 repeating units. This degree of polymerisation is determined via the number average of the molecular weight Mₙ, which can be determined by means of GPC methods. Due to the problems of isolating the polymers comprising phosphonic acid groups contained in the membrane without degradation, this value is determined by means of a sample which is obtained by polymerisation of monomers comprising phosphonic acid groups without addition of polymer. In this connection, the weight proportion of monomers comprising phosphonic acid groups and of radical starters in comparison to the ratios of the production of the membrane is kept constant. The conversion achieved in a comparative polymerisation is preferably greater than or equal to 20%, in particular greater than or equal to 40% and particularly preferably greater than or equal to 75%, based on the monomers comprising phosphonic acid groups used.

The hydrolysis fluid comprises water wherein the concentration of the water generally is not particularly critical. According to a particular aspect of the present invention, the hydrolysis fluid comprises 5 to 80% by weight, preferably 8 to 70% by weight and particularly preferably 10 to 50% by weight, of water. The amount of water which is formally included in the oxo acids is not taken into account in the water content of the hydrolysis fluid.

Of the above-mentioned acids, phosphoric acid and/or sulphuric acid are particularly preferred wherein these acids comprise in particular 5 to 70% by weight, preferably 10 to 60% by weight and particularly preferably 15 to 50% by weight, of water.

The partial hydrolysis of the polyphosphoric acid in step D) leads to a solidification of the membrane due to a sol-gel transition. This is also connected with a reduction in the layer thickness to 15 to 3000 μm, preferably between 20 and 2000 μm, in particular between 20 and 1500 μm; the membrane is self-supporting.

The intramolecular and intermolecular structures (interpenetrating networks IPN) present in the polyphosphoric acid layer in accordance with step B) lead to an ordered membrane formation in step C), which is responsible for the particular properties of the membrane formed.

The upper temperature limit for the treatment in accordance with step D) is typically 150° C. With extremely short action of moisture, for example from overheated steam, this steam can also be hotter than 150° C. The duration of the treatment is substantial for the upper limit of the temperature.

The partial hydrolysis (step D) can also take place in climatic chambers where the hydrolysis can be specifically controlled with defined moisture action. In this connection, the moisture can be specifically set via the temperature or saturation of the surrounding area in contact with it, for example gases such as air, nitrogen, carbon dioxide or other suitable gases, or steam. The duration of the treatment depends on the parameters chosen as aforesaid.

Furthermore, the duration of the treatment depends on the membrane thicknesses.

Typically, the duration of the treatment amounts to between a few seconds to minutes, for example with the action of overheated steam, or up to whole days, for example in the open air at room temperature and low relative humidity. Preferably, the duration of the treatment is between 10 seconds and 300 hours, in particular 1 minute to 200 hours.

If the partial hydrolysis is performed at room temperature (20° C.) with ambient air having a relative humidity of 40-80%, the duration of the treatment is between 1 and 200 hours.

The membrane obtained in accordance with step D) can be formed in such a way that it is self-supporting, i.e. it can be detached from the support without any damage and then directly processed further, if applicable.

The concentration of phosphoric acid and therefore the conductivity of the polymer membrane can be set via the degree of hydrolysis, i.e. the duration, temperature and ambient humidity. The concentration of the phosphoric acid is given as mole of acid per mole of repeating unit of the polymer. Membranes with a particularly high concentration of phosphoric acid can be obtained by the method comprising the steps A) to D). A concentration (mol of phosphoric acid, based on a repeating unit of formula (I), for example polybenzimidazole) of 10 to 50, in particular between 12 and 40 is preferred. Only with very much difficulty or not at all is it possible to obtain such high degrees of doping (concentrations) by doping polyazoles with commercially available orthophosphoric acid.

According to a modification of the method described wherein doped polyazole films are produced by use of polyphosphoric acid, the production of these films can be carried out by a method comprising the following steps:
1) reacting one or more aromatic tetramino compounds with one or more aromatic carboxylic acids or their esters, which contain at least two acid groups per carboxylic acid monomer, or one or more aromatic and/or heteroaromatic diaminocarboxylic acids in the melt at temperatures of up to 350° C., preferably up to 300° C.,
2) dissolving the solid prepolymer obtained in accordance with step 1) in polyphosphoric acid,
3) heating the solution obtainable in accordance with step 2) under inert gas to temperatures of up to 300° C., preferably up to 280° C., with formation of the dissolved polyazole polymer,
4) forming a membrane using the solution of the polyazole polymer in accordance with step 3) on a support and
5) treating the membrane formed in step 4) until it is self-supporting.

The steps of the method described under items 1) to 5) have been explained before in detail for the steps A) to D), where reference is made thereto, in particular with regard to preferred embodiments.

A membrane, particularly a membrane based on polyazoles, can further be cross-linked at the surface by action of heat in the presence of atmospheric oxygen. This hardening of the membrane surface further improves the properties of the membrane. To this end, the membrane can be heated to a temperature of at least 150° C., preferably at least 200° C. and particularly preferably at least 250° C. In this step of the method, the oxygen concentration usually is in the range of 5 to 50% by volume, preferably 10 to 40% by volume; however, this should not constitute a limitation.

The cross-linking can also take place by action of IR or NIR (IR=infrared, i.e. light having a wavelength of more than 700 nm; NIR=near-IR, i.e. light having a wavelength in the range of from about 700 to 2000 nm and an energy in the range of from about 0.6 to 1.75 eV), respectively. Another method is β-ray irradiation. In this connection, the irradiation dose is from 5 to 200 kGy.

Depending on the degree of cross-linking desired, the duration of the cross-linking reaction can be within a wide range. In general, this reaction time lies in the range of 1 second to 10 hours, preferably 1 minute to 1 hour; however, this should not constitute a limitation.

Particularly preferred polymer membranes display a high performance. The reason for this is in particular improved proton conductivity. This is at least 1 mS/cm, preferably at least 2 mS/cm, in particular at least 5 mS/cm at temperatures of 120° C. Here, these values are achieved without moistening. Therefore, the membranes are suitable as so called high-temperature, polymer electrolyte membrane fuel cells and to produce high-temperature membrane electrode assemblies. The aforementioned high-temperature proton conductivity can be accomplished by proton-conducting polymer electrolyte membranes and matrices comprising (i) a basic polymer material or matrix and an acid which allows for the so-called “Grotthus mechanism” or a (ii) a polymer material having covalently bound groups which allows for the so-called “Grotthus mechanism”. In the latter case, this is typically achieved by incorporating at least 10% by weight of polymers derived from the aforementioned monomers comprising phosphonic acid groups.

The specific conductivity is measured by means of impedance spectroscopy in a 4-pole arrangement in potentiostatic mode and using platinum electrodes (wire, diameter of 0.25 mm). The gap between the current-collecting electrodes is 2 cm. The spectrum obtained is evaluated using a simple model comprised of a parallel arrangement of an ohmic resistance and a capacitor. The cross section of the sample of the membrane doped with phosphoric acid is measured immediately prior to mounting of the sample. To measure the temperature dependency, the measurement cell is brought to the desired temperature in an oven and regulated using a Pt-100 thermocouple arranged in the immediate vicinity of the sample. Once the temperature is reached, the sample is held at this temperature for 10 minutes prior to the start of measurement.

### Gas Diffusion Layer

The membrane electrode assembly according to the invention has two gas diffusion layers which are separated by the polymer electrolyte membrane.

Mechanically stabilizing materials which are very light, not necessarily electrically conductive, but mechanically stable and contain fibres, for example, in the form of non-woven fabrics, paper or woven fabrics are used as the starting material for the gas diffusion layers according to the invention. These include, for example, graphite-fibre paper, carbon-fibre paper, graphite fabric and/or paper which was rendered conductive by addition of carbon black. Through these layers, a fine distribution of the flows of gas and/or liquid is achieved.

The mechanically stabilizing material preferably contains carbon fibres, glass fibres or fibres containing organic polymers, for example polypropylene, polyester (polyethylene terephthalate), polyphenylenesulphide or polyether ketones, to name only a few. In this connection, materials with a weight per unit area <150 g/m², preferably with a weight per unit area in the range of 10 to 100 g/m² are particularly well suited.

When using carbon materials as stabilizing materials, non-woven fabrics made of carbonised or graphitised fibres with weights per unit area within the preferred range are particularly suited. Using such materials has two advantages: Firstly, they are very light and secondly, they have a high open porosity. The open porosity of the stabilizing materials used with preference is within the range of 20 to 99.9%, preferably 40 to 99%, such that they can easily be filled with other materials and the porosity, conductivity and hydrophobicity of the finished gas diffusion layer thus can be adjusted in a directed manner, namely throughout the entire thickness of the gas diffusion layer.

Generally, this layer has a thickness in the range of 80 μm to 2000 μm, in particular 100 μm to 1000 μm and particularly preferably 150 μm to 500 μm.

The production of gas diffusion layers or gas diffusion electrodes is described in detail in WO 97/20358, for example. The production methods set out therein are also part of the present description.

To reduce the surface tension, materials (additives or detergents) can be added, such as described in detail in WO 97/20358. Additionally, the hydrophobicity of the gas diffusion layer can be set by using perfluorinated polymers together with non-fluorinated binders. Subsequently, the equipped gas diffusion layers are dried and after-treated thermally, for example by sintering at temperatures of more than 200° C.

Furthermore, it is possible to construct the gas diffusion layer with several layers. In a preferred embodiment of the gas diffusion layer, it has at least 2 distinguishable layers. 4 layers are considered as an upper limit for multi-layered gas diffusion layers. If more than one layer is used, it is convenient to form an intimate connection of these layers with each other by means of a compression or lamination step, preferably at a higher temperature. By using multi-layered gas diffusion layers, it is possible to produce pre-trimmed layers, by means of which gradients of effective porosity and/or hydrophobicity can be set. Such gradients can also be generated by several successive coating or impregnating steps which, however, is typically more elaborate to implement.

According to a particular embodiment, at least one of the gas diffusion layers can consist of a compressible material. Within the scope of the present invention, a compressible material is characterized by the property that the gas diffusion layer can be compressed to half, in particular a third of its original thickness without losing its integrity.

The gas diffusion layers according to the invention have a low electrical surface resistivity which is in the range of <100 mOhm per cm², preferably <60 mOhm per cm².

This property is generally exhibited by a gas diffusion layer made of graphite fabric and/or graphite paper which were rendered conductive by addition of carbon black. The gas diffusion layers are usually also optimised in respect of their hydrophobicity and mass transfer properties by the addition of further materials. In this connection, the gas diffusion layers are equipped with fluorinated or partially fluorinated materials, for example PTFE.

### Catalyst Layer

The catalyst layer or catalyst layers contains or contain catalytically active substances. These include, amongst others, precious metals of the platinum group, i.e. Pt, Pd, Ir, Rh, Os, Ru, or also the precious metals Au and Ag. Furthermore, alloys of all the above-mentioned metals may also be used. Additionally, at least one catalyst layer can contain alloys of the elements of the platinum group with non-precious metals, such as for example Fe, Co, Ni, Cr, Mn, Zr, Ti, Ga, V, etc. Furthermore, the oxides of the above-mentioned precious metals and/or non-precious metals can also be used.

The catalytically active particles which comprise the above-mentioned substances can be used as metal powder, in particular platinum and/or platinum alloy powder, so-called black precious metal. Such particles generally have a size in the range of 5 nm to 200 nm, preferably in the range of 7 nm to 100 nm. So-called nano particles are also used.

Furthermore, the metals can also be used on a support material. Preferably, this support comprises carbon which particularly may be used in the form of carbon black, graphite or graphitised carbon black. Furthermore, electrically conductive metal oxides, such as for example, SnOₓ, TiOₓ, or phosphates, such as e.g. FePOₓ, NbPOₓ, Zr_{y}(POₓ)_{z}, can be used as support material. In this connection, the indices x, y and z designate the oxygen or metal content of the individual compounds which can lie within a known range as the transition metals can be in different oxidation stages.

The content of these metal particles on a support, based on the total weight of the bond of metal and support, is generally in the range of 1 to 80% by weight, preferably 5 to 60% by weight and particularly preferably 10 to 50% by weight; however, this should not constitute a limitation. The particle size of the support, in particular the size of the carbon particles, is preferably in the range of 20 to 1000 nm, in particular 30 to 100 nm. The size of the metal particles present thereon is preferably in the range of 1 to 20 nm, in particular 1 to 10 nm and particularly preferably 2 to 6 nm.

The sizes of the different particles represent mean values and can be determined via transmission electron microscopy or X-ray powder diffractometry.

The catalytically active particles set forth above can generally be obtained commercially.

Besides the catalysts or catalyst particles already commercially available, catalyst nano particles made of platinum-containing alloys, in particular based on Pt, Co and Cu or Pt, Ni and Cu, respectively, can also be used in which the particles in the outer shell have a higher Pt content as in the core. Such particles were described by P. Strasser et al. in Angewandte Chemie 2007.

Furthermore, the catalytically active layer may contain customary additives. These include, amongst others, fluoropolymers, such as e.g. polytetrafluoroethylene (PTFE), proton-conducting ionomers and surface-active substances.

According to a particular embodiment of the present invention, the weight ratio of fluoropolymer to catalyst material comprising at least one noble metal and optionally one or more support materials is greater than 0.1, this ratio preferably lying within the range of 0.2 to 0.6.

According to a particular embodiment of the present invention, the catalyst layer has a thickness in the range of 1 to 1000 μm, in particular from 5 to 500, preferably from 10 to 300 μm. This value represents a mean value, which can be determined by using cross-section images of the layer that can be obtained with a scanning electron microscope (SEM).

According to a particular embodiment of the present invention, the content of noble metals of the catalyst layer is 0.1 to 10.0 mg/cm², preferably 0.3 to 6.0 mg/cm² and particularly preferably 1 to 4.0 mg/cm². These values can be determined by elemental analysis of a flat sample.

It is preferred to have the ionomeric material according to the instant invention being present on the catalyst layer at the cathode in a certain ratio to the content of catalyst material. Hence, it is preferred to have a weight ratio between ionomeric material and catalyst from 100:1 to 1:100, most preferred from 10:1 to 1:10. A specific preferred ratio is from 1:8 to 1:3. These amounts and ratio's also apply to catalyst layers in the anode, if desired.

The catalyst layer is in general not self-supporting but is usually applied to the gas diffusion layer and/or the membrane. In this connection, a part of the catalyst layer can, for example, diffuse into the gas diffusion layer and/or the membrane, resulting in the formation of transition layers. This can also lead to the catalyst layer being understood as part of the gas diffusion layer. The thickness of the catalyst layer results from measuring the thickness of the layer onto which the catalyst layer was applied, for example the gas diffusion layer or the membrane, the measurement providing the sum of the catalyst layer and the corresponding layer, for example the sum of the gas diffusion layer and the catalyst layer. The catalyst layers preferably feature gradients, i.e. the content of precious metals increases in the direction of the membrane while the content of hydrophobic materials is behaving contrarily.

For further information on membrane electrode assemblies, reference is made to the technical literature, in particular the patent applications WO 01/18894 A2, DE 195 09 748, DE 195 09 749, WO 00/26982, WO 92/15121 and DE 197 57 492. The disclosure contained in the above-mentioned references with respect to the structure and production of membrane electrode assemblies as well as the electrodes, gas diffusion layers and catalysts to be chosen is also part of the description.

### Gaskets

The gaskets used or generated within the scope of the method according to the invention are either produced in a separate step and applied or else directly generated on the circumferential edge of the gas diffusion layer and the circumferential, optionally raised edge of the bipolar plate.

In this connection, it is essential that the gasket in the formed, constructional inner boundary area overlaps inwards and thus overlaps the outer boundary area of the gas diffusion layer or the gas diffusion layer provided with a catalyst layer. Through this overlap, the gas diffusion layer is fixed in the bipolar plate such that further positioning or fixing frames can be dispensed with. Additionally, no longer does the boundary area of the gas diffusion layer have to be interspersed with sealing material or does the sealing material have to penetrate the boundary area of the gas diffusion layer to achieve the sealing function.

Furthermore, it is advantageous if the gasket possesses a sufficient mechanical stability and/or integrity such that in a subsequent compression step, for example, the gas diffusion layer and/or the membrane/electrolyte matrix will not be damaged. To this end, a so-called hard stop function may be integrated into the gasket in an advantageous manner. This embodiment is particularly preferred when the gasket is produced on a bipolar plate without a raised edge.

Production of the gasket can be performed in a separate step or else the gasket is generated directly on the circumferential edge of the gas diffusion layer towards the bipolar plate. Formation of the gasket can be performed by means of all the known methods, preferably by the spray-application of thermoplastic elastomers or cross-linkable rubbers or the application and/or cross-linking of these by means of printing methods.

Preferably, the gaskets according to the invention are formed from meltable polymers or rubbers which can be processed thermally.

Among the rubbers, silicone rubber (Q), ethylene-propylene-diene rubber (EPDM), ethylene-propylene rubber (EPM), isobutylene-isoprene rubber (IIR), butadiene rubber (BR), styrene-butadiene rubber (SBR), styrene-isoprene rubber (SIR), isoprene-butadiene rubber (IBR), isoprene rubber (IR), acrylonitrile-butadiene rubber (NBR), chloroprene rubber (CR), acrylate rubber (ACM) and/or partially hydrogenated rubber from butadiene rubber (BR), styrene-butadiene rubber (SBR), isoprene-butadiene rubber (IBR), isoprene rubber (IR), acrylonitrile-butadiene rubber (NBR), polyisobutylene rubber (PIB), fluoro rubber (FPM), fluorosilicone rubber (MFQ, FVMQ) are preferred.

Furthermore, fluoropolymers are used as sealing material, preferably poly(tetrafluoroethylene-co-hexafluoropropylene) FEP, polyvinylidene fluoride PVDF, perfluoroalkoxy polymer PFA and poly(tetrafluoroethylene-co-perfluoro(methylvinyl ether) MFA. These polymers are commercially available in many ways, for example under the trade names Hostafon®, Hyflon®, Teflon®, Dyneon® and Nowoflon®.

Apart from the materials mentioned above, sealing materials based on polyimides can also be used. The class of polymers based on polyimides also includes polymers also containing, besides imide groups, amide (polyamideimides), ester (polyesterimides) and ether groups (polyetherimides) as components of the backbone.

Preferred polyimides have recurring units of the formula (VI)

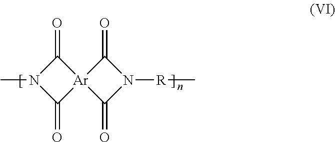

wherein the functional group Ar has the meaning set forth above and the functional group R represents an alkyl group or a bicovalent aromatic or heteroaromatic group with 1 to 40 carbon atoms. Preferably, the functional group R represents a bicovalent aromatic or heteroaromatic group derived from benzene, naphthalene, biphenyl, diphenyl ether, diphenyl ketone, diphenylmethane, diphenyldimethylmethane, bisphenone, diphenylsulphone, quinoline, pyridine, bipyridine, anthracene, thiadiazole and phenanthrene which optionally also can be substituted. The index n suggests that the recurring units represent parts of polymers.

Such polymers are commercially available under the trade names ®Kapton, ®Vespel, ®Toray and ®Pyralin from DuPont as well as ®Ultem from GE Plastics and ®Upilex from Ube Industries.

Combinations of the above-mentioned materials with the property combination soft/hard are also suitable as sealing material, in particular when the above-mentioned hard stop function is to be integrated.

Particularly preferred sealing materials have a Shore A hardness of 5 to 85, in particular of 25 to 80. The Shore hardness is determined according to DIN 53505. Furthermore, it is advantageous when the permanent set of the sealing material is lower than 50%. The permanent set is determined according to DIN ISO 815.

The thickness of the gaskets is influenced by several factors. An essential factor is how high the elevation in the boundary area of the bipolar plate is chosen. Usually, the thickness of the gasket generated or applied is 5 μm to 5000 μm, preferably 10 μm to 1000 μm and in particular 25 μm to 150 μm. In particular in the case of bipolar plates without a raised boundary area, the thickness can also be higher.

The gaskets can also be constructed with several layers. In this embodiment, different layers are connected with each other using suitable polymers, in particular fluoropolymers being well suited to establish an adequate connection. Suitable fluoropolymers are known to those in professional circles. These include, amongst others, polytetrafluoroethylene (PTFE) and poly(tetrafluoroethylene-co-hexafluoropropylene) (FEP). The layer made of fluoropolymers present on the sealing layers described above in general has a thickness of at least 0.5 μm, in particular at least 2.5 μm. If expanded fluoropolymers are applied, the thickness of the layer can be 5 to 250 μm, preferably 10 to 150 μm.

The gaskets or sealing materials described above are such that they fix the gas diffusion layer in the recess which is formed together with the bipolar plate. To this end, it is advantageous when the gasket overlaps the outer boundary area of the gas diffusion layer circumferentially. The overlap of the gasket with the boundary area of the gas diffusion layer is preferably 0.1 to 5 mm, preferably 0.1 to 3 mm, based on the outermost edge of the gas diffusion layer. A greater overlap is possible, but leads to a strong loss in catalytically active surface. For this reason, the degree of overlapping has to be balanced in a critical way so that an unnecessarily excessive part of the catalytically active surface is covered.

Though it is advantageous when the gasket overlaps the boundary area of the gas diffusion layer circumferentially, nonetheless, discontinouities in the overlap of the circumferential sealing edge with the boundary area of the gas diffusion layer can also exist, in particular with respect to the active catalytic surface. In this connection, it is essential that the fixing function of the gas diffusion layer remains ensured through the gasket.

### Bipolar Plates

The bipolar plates or also separator plates used within the scope of the present invention are typically provided with process media channels (flow field channels) to permit the distribution of the reactants and other fluids typical for fuel cells, for example cooling fluids.

The bipolar plates are usually formed from electrically conductive materials; these may be metallic or non-metallic materials.

If the bipolar plates are constructed from non-metallic materials, so-called composite materials are preferred. Composite materials are composites made of a matrix material which are provided with electrically conductive fillers. Polymeric materials, in particular organic polymers are preferably suited as the matrix material. Depending on the operating temperature of the fuel cell, high-performance polymers, in particular thermally stable polymers can also be required. Depending on the field of use, polymers are used whose long-term service temperature is at least 80° C., preferably at least 120° C., particularly preferably at least 180° C.

Thermoplastics, in particular polypropylene (PP), polyvinylidene fluoride (PVDF), polytetrafluoroethylene (PTFE), polyphenylene sulphide (PPS) and liquid-crystalline polymers (LCP) are used with particular preference, it also being possible to use these as compounds, i.e. admixed with other polymers and typical additives, respectively. Besides the thermoplastics, thermosetting plastics and resins are also preferred. In particular, phenol resins (PF), melamine resins (MF), polyester (UP) and epoxy resins (EP) are used.

Particulate substances which permit a distribution as homogenous as possible in the matrix are used as electrically conductive fillers. Preferably, these fillers possess a bulk conductivity of at least 10 mS/cm. Carbons, graphites and carbon blacks are used with particular preference. These can also be treated to achieve a better wettability with the matrix material. The particle size is not subject to any particular limitation, but has to permit the production of such bipolar plates. Apart from the above-mentioned electrically conductive fillers, even further additives which are to improve the application properties can be added to the matrix materials. Fibre reinforcements are also possible, in particular if the mechanical load can otherwise not be ensured.

Producing such bipolar plates is preferably performed by means of suitable forming methods, in particular by means of injection moulding techniques as well as injection embossing and embossing techniques.

Besides the process media ducts, the bipolar plates can also have further ducts or openings or bores through which coolants or reaction gases, for example, can be supplied and discharged.

The thickness of the non-metallic bipolar plates is preferably within the range of 0.3 to 10 mm, in particular within the range of 0.5 to 5 mm and particularly preferably within the range of 0.5 to 2 mm. The conductivity of the non-metallic bipolar plates is greater than or equal to 25 S/cm.

If the bipolar plates are constructed from metallic materials, more cost-efficient integral designs are possible. The construction of such metallic bipolar plates is not subject to any substantial limitation.

Corrosion-resistant and acid-resistant steels are preferred as metallic materials, in particular those based on V2A and V4A steels as well as those made of nickel-based alloys. Plated or coated metals are further preferred, in particular those with corrosion-resistant surfaces made of precious metals, nickel, ruthenium, niobium, tantalum, chromium, carbon as well as metals coated with ceramic materials, in particular coats made of CrN, TiN, TiAlN, complex nitrides, carbides, silicides and oxides of metals and transition metals.

Aside from these, the metallic bipolar plates can additionally have such coats which, on the one hand, reduce the electrical surface resistivity of the junction of gas diffusion layer/bipolar plate or else increase the chemical and/or physical resistance of the bipolar plate towards the media present or formed in fuel cells.

The construction of metallic bipolar plates can take place from individual plates, it thus being possible in a simple manner to form voids for coolants or reaction media which have to be supplied and discharged. The connection of the individual plates can be performed by material bonding methods, such as, for example, welding or soldering. If necessary, the voids are additionally sealed with respect to each other, e.g. by means of further internal coats such that leakages can be avoided.

If fuel cell systems free of cooling layers are constructed or such systems in which several individual cells of the fuel cell stack do not require any cooling, the bipolar plates or individual bipolar plates in the stack may also be manufactured from only one metallic or non-metallic individual plate.

The construction and production of suitable metallic bipolar plates are described in detail in DE-A-10250991, WO 2004/036677, WO 2004/105164, WO 2005/081614, WO 2005/096421 and WO 2006/037661. The assemblies and production methods set out therein are also part of the present invention and description.

The thickness of the metallic bipolar plates is preferably within the range of 0.03 to 1 mm, in particular within the range of 0.05 to 0.5 mm and particularly preferably within the range of 0.05 to 0.15 mm.

The bipolar plates used within the scope of the present invention may have a raised boundary area such that the area of the bipolar plate containing the channels of the flow field forms a recess. The exact height of the boundary area in relation to the highest elevation of the area of the bipolar plate having the process media channels is adapted to the thickness of the gas diffusion layer or the gas diffusion layer with a catalyst layer. If the gas diffusion layer or the gas diffusion layer with a catalyst layer is not to be subjected to any further compression during the subsequent compression step, the elevation of the boundary area of the bipolar plate corresponds to the thickness of the gas diffusion layer or the gas diffusion layer with a catalyst layer.

If the thickness of the gas diffusion layer or the gas diffusion layer with a catalyst layer is higher than the height of the boundary area opposite the highest elevation of the area of the bipolar plate having the process media ducts, a compression of the gas diffusion layer results during the subsequent compression step. The degree of compression is determined via the thickness and formability of the sealing material such that the sealing material acts as a hard stop. This embodiment is particularly advantageous when soft or easily formable polymer electrolyte membranes are used as damage to the membrane can be avoided.

It has been found that it is advantageous to design the elevation of the boundary area or the elevation through the frame-shaped component in such a way that the gas diffusion layer or the gas diffusion layer with a catalyst layer experiences a compression of at least 3% compared to the original thickness. Particularly preferably, the above-described elevation of the boundary area is chosen such that the compression is at least 5%. A compression of more than 50%, in particular of more than 30% is chosen as the upper limit, it being possible to also exceed this through the choice of other parameters.

The compression of the components is performed by the action of pressure and temperature such that an intimate connection of the components with each other is formed. In general, this is carried out at a temperature in the range of 10 to 300° C., in particular 20° C. to 200° C. and with a pressure in the range of 1 to 1000 bar, in particular of from 3 to 300 bar. The above-mentioned compression can also take place during the production of the stack and/or when starting-up the fuel cell stack.

Afterwards, the electrochemical cell, in particular individual cell for fuel cells is operational and can be used. To produce a fuel cell stack, the underlying individual cells for fuel cells are arranged as a stack. Furthermore, the production of the fuel cell stack can be performed by using the semi-finished parts according to the invention, it being possible to provide these beforehand with the required membrane. In this connection, the membrane is previously available as rolled goods, for example, and can be cut individually to be adapted to the respective bipolar plate design, with minimal use of materials. No handling frame needs to be added. The production of fuel cell stacks from individual cells for fuel cells is generally known.

The electrodes and membrane electrode assembly according to the instant invention provides, as described in the examples below, polymer which contains fluorine and at the same time imino group that allows adsorption of phosphoric acid. When it is used as ionomer coated on electrodes, gives significantly higher oxygen reduction current is obtained. Accordingly, it was shown that the overpotential of electrode is reduced, and the voltage of fuel cell increases. Without being bond to a particular scientific model, such effect may be explained by the fact that the inclusion of fluorine in the polymer structure increases its own oxygen solubility. With this invention, it was made clear that the method to add or coat such fluorine-containing polymer to cathode is an effective measure to improve performance of fuel cell.

### Polymer Preparation Procedures

Polymer 1: Polybenzimidazole (PBI) As a basis polymer for comparison poly(2,2′-m-phenylene-5,5′-bibenzimidazole) from BASF Fuel Cell GmbH is used.
Polymer 2: Fluorine-containing polymer 1

4,4′-(Hexafluoroisopropylidene) dibenzoic acid, shown in Formula 1, was used as dicarboxylic acid, and 3,3′-diaminobenzidine tetrahydrochloride, shown in Formula 2, was used as a monomer containing amino group.

Under nitrogen atmosphere, using polyphosphoric acid (117% phosphoric acid) as reaction solvent, the reaction took place at 170° C. for 12 hours, and further at 220° C. for 90 hours. The reaction mixture became highly viscous.

The mixture was poured to large amount of water, and precipitate was collected by filtration. The precipitate was put into boiling water and refluxed for 24 hours in order to remove solvent polyphosphoric acid. Infrared spectroscopy showed absorption of imino group (C═N) at 1633 cm⁻¹, and imidazol ring at 3400-2600 cm⁻¹, which confirmed the Molecular structure 1.

Molecular weight was measured by GPC (Gel permeation chromatography) using PEO as internal standard material. Based on result of the measurement, the number average molecular weight Mn was 6.0×10⁴, and the weight average molecular weight Mw was 31×10⁴.

This polymer was soluble in organic solvents, such as Dimethyl Acetamide and NMP(N-Methylpyrrolidone).

A 5 wt % solution of the polymer was spread on a glass plate, and after removal of the solvent by heating, brown tough film was finally obtained. It is confirmed that by dipping in 85% phosphoric acid at 40° C. for one hour, the film can be transformed to gel film containing 75-80 wt % of phosphoric acid.

### Polymer 3: Fluorine-Containing Polymer 2

4,4′-Oxybis[benzoic acid], shown in Formula 3, was used as dicarboxylic acid, and 2,2-Bis (3-amino-4-hydroxyphenyl) Hexafluoropropane dihydrochloride, shown in Formula 4, was used as a monomer containing amino group.

Under nitrogen atmosphere, using polyphosphoric acid (117% phosphoric acid) as reaction solvent, the reaction took place at 170° C. for 4 hours, and further at 203° C. for 34 hours. The reaction mixture became highly viscous.

The mixture was poured to large amount of water, and precipitate was collected by filtration. The precipitate was put into boiling water and refluxed for 24 hours in order to remove solvent polyphosphoric acid. Infrared spectroscopy showed absorption of imino group (C═N) at 1599 cm⁻¹, imidazol ring at 3400-2600 cm⁻¹ and C—O—C at 1246 cm⁻¹, which confirmed the Molecular structure 2.

Molecular weight was measured by GPC (Gel permeation chromatography) using PEO as internal standard material. Based on result of the measurement, the number average molecular weight Mn was 0.57×10⁴, and the weight average molecular weight Mw was 1.7×10⁴.

This polymer was soluble in organic solvents, such as Acetoamide and NMP(N-Methylpyrrolidone).

A 5 wt % solution of the polymer was spread on a glass plate, and after removal of the solvent by heating, brown rigid film was finally obtained. It is confirmed that by dipping in 85% phosphoric acid at 40° C. for one hour, the film can be transformed to gel film containing 50-60 wt % of phosphoric acid.

Polymer 4: Fluorine-containing polymer 3

Sebacic acid, shown in Formula 5, was used as dicarboxylic acid, and 2,2-Bis (3-amino-4-hydroxyphenyl) Hexafluoropropane dihydrochloride, shown in Formula 6, was used as a monomer containing amino group.

Under nitrogen atmosphere, using polyphosphoric acid (117% phosphoric acid) as reaction solvent, the reaction took place at 130° C. for 1 hour, and further at 180° C. for 24 hours. The reaction mixture became highly viscous.

The mixture was poured to large amount of water, and precipitate was collected by filtration. The precipitate was put into boiling water and refluxed for 24 hours in order to remove solvent polyphosphoric acid. Infrared spectroscopy showed absorption of imino group (C═N) at 1629 cm⁻¹, and imidazol ring at 3400-2600 cm⁻¹, which confirmed the Molecular structure 3.

This polymer was soluble in organic solvents, such as Dimethyl Acetamide and NMP(N-Methylpyrrolidone).

A 5 wt % solution of the polymer was spread on a glass plate, and after removal of the solvent by heating, brown rigid film was finally obtained. It is confirmed that by dipping in 85% phosphoric acid at 40° C. for one hour, the film can be transformed to gel film containing 70-75 wt % of phosphoric acid.

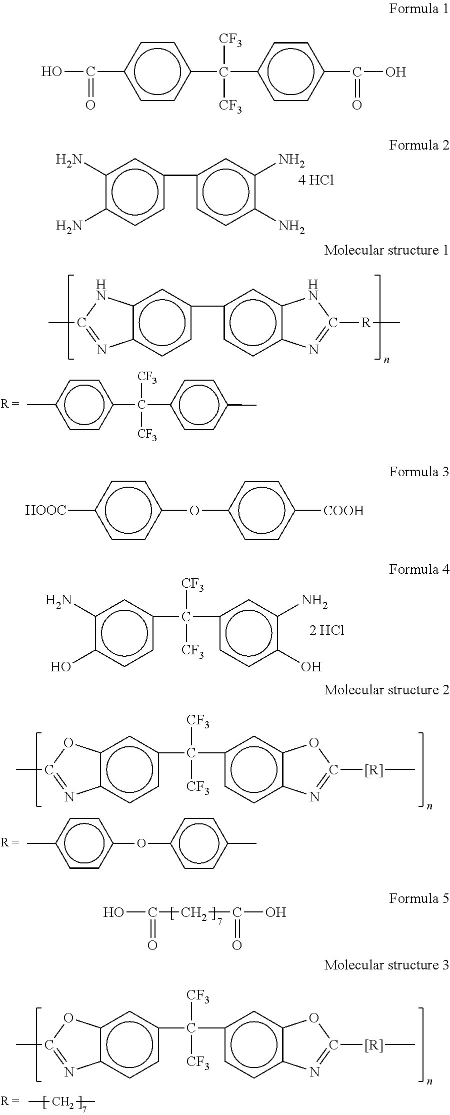

### Electrochemical Measurements

### a) Electrode Preparation

In order to measure the electrochemical oxygen reduction activity of electrodes containing the polymers described above, half cell measurements have been performed. As a reference and counter electrode a porous Pt-carbon electrode with 0.5 mg/cm² Pt loading was used. As electrolyte a phosphoric acid doped polybenzimidazole membrane (80% wt using 85% phosphoric acid) was used. The working electrodes were prepared by dipping a Pt mesh electrode (1 cm² geometric area) into a solution of the respective polymer 3˜5 wt % of Dimethyl Acetamide solvent with subsequent evaporation of the solvent. The resulting polymer coatings are quantified in table 1.

TABLE 1
Table 1: Polymer coating weights on working electrodes

| | Platinum coating amount | Polymer coating amount |
|---|---|---|
| | [mg/cm²] | [mg/cm²] |
| Pt-Mesh | 3.5 | — |
| Pt-Mesh/Polymer 1 | 3.7 | 0.8 |
| (PBI) | | |
| Pt-Mesh/Polymer 2 | 3.0 | 0.7 |
| Pt-Mesh/Polymer 3 | 3.6 | 0.6 |
| Pt-Mesh/Polymer 4 | 3.9 | 0.8 |

### b) Electrochemical Measurements

The electrochemical measurements are performed by pressing the counter/reference electrode, the acid loaded PBI membrane and the working electrode between two graphite plates with gas inlets/outlets. The measurements are carried out at 140° C. The counter/reference electrode is continuously purged with hydrogen. The working electrode is either continuously purged with 0.4 L/min pure oxygen or with air (high flow rates to ensure gas utilization of close to zero). Activity of the electrodes at 0.7V and 140° C. (ambient pressure) is summarized in table 2.

TABLE 2
Table 2: Oxygen reduction activities of electrodes from this invention
(note that the reduction currents are denoted as positive currents in
this table)

| | pure O₂ | Air, |
|---|---|---|
| | I [mA/cm²] at 0.7 V | I [mA/cm²] at 0.7 V |
| Pt-Mesh | 0.80 | 0.20 |
| Pt-Mesh/Polymer 1 (PBI) | 0.67 | 0.13 |
| Pt-Mesh/Polymer 2 | 2.03 | 0.32 |
| Pt-Mesh/Polymer 3 | 1.59 | 0.36 |
| Pt-Mesh/Polymer 4 | 6.14 | 1.35 |

1-18. (canceled)

19. A membrane electrode assembly comprising:
(i) at least two electrochemically active electrodes,
(ii) said electrodes being separated by at least one polymer electrolyte membrane or electrolyte matrices,
(iii) said electrodes having a catalyst layer being in contact with the above-mentioned polymer electrolyte membrane or matrices,
(iv) said catalyst layer comprising at least one ionomeric material,
wherein at least the catalyst layer being in contact with the cathode comprises a polymer comprising the recurring units of the general formula (I) 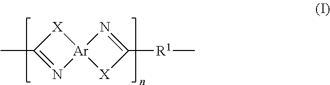
wherein (a)
Ar are identical or different and represent a tetracovalent aromatic group or tetracovalent heteroaromatic group, each can be monocyclic, bicyclic or polycyclic, and
X are identical or different and represent N, O or S and
R¹ are identical or different and represent a bicovalent group of the formula 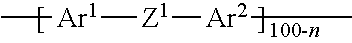
and,
Ar¹ and Ar² are identical or different and represent a bicovalent aromatic group or bicovalent heteroaromatic group, each can be monocyclic, bicyclic or polycyclic, and,
Z¹ are identical or different and represent an bivalent alkyl group and/or an bivalent aromatic group, both in which at least one hydrogen atom is replaced by a fluorine atom, and
n is 0.1 to 99.9 mol-%,
or (b)
Ar are identical or different and represent a tetracovalent group of the formula 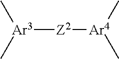
Ar³ and Ar⁴ are identical or different and represent a tricovalent aromatic group or tricovalent heteroaromatic group, each can be monocyclic, bicyclic or polycyclic, and,
Z² are identical or different and represent an bivalent alkyl group and/or an bivalent aromatic group, both in which at least one hydrogen atom is replaced by a fluorine atom, and
X are identical or different and represent N, O or S and
R¹ are identical or different and represent (i) a bicovalent group of the formula 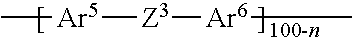
and,
Ar⁵ and Ar⁶ are identical or different and represent a bicovalent aromatic group or bicovalent heteroaromatic group, each can be monocyclic, bicyclic or polycyclic, and,
Z³ are identical or different and represent N, O or S,
or (ii) a bivalent alkyl group and/or an bivalent aromatic group, both of which can be further substituted,
and
n is 0.1 to 99.9 mol-%,
as ionomeric material.

20. The membrane electrode assembly as claimed in claim 19, whereas in both alternatives (a) or (b) n is between 40 to 60 mol-%, so that the ratio between both subunits of the recurring units is comparable or equal.

21. The membrane electrode assembly as claimed in claim 19, whereas in both alternatives (a) or (b) n is 50 mol-%, so that the ratio between both subunits of the recurring units is comparable or equal.

22. The membrane electrode assembly as claimed in claim 19, whereas in both alternatives (a) or (b) X stands for N or O.

23. The membrane electrode assembly as claimed in claim 19, whereas in alternative (b) X stands for O.

24. The membrane electrode assembly as claimed in claim 19, whereas alkyl in Z¹ and/or Z², independent of each other, stand for short-chain bivalent alkyl groups having from 1 to 6 carbon atoms.

25. The membrane electrode assembly as claimed in claim 19, whereas alkyl in Z¹ and/or Z², independent of each other, stand for methyl, ethyl, n-propyl or i-propyl and n-, i-, or t-butyl, n-, i-, or t-pentane, n i-, or t-hexane, in which at least one carbon atom is perfluorinated or at least one carbon atom is substituted by at least one (CF₃)-group.

26. The membrane electrode assembly as claimed in claim 19, whereas aromatic group in Z¹ and/or Z², independent of each other, stand for bivalent aromatic groups having 5 to 6 carbon atoms, in which one or more carbon atoms can be replaced by a heteroatom selected from N, O or S, in which at least one carbon atom is perfluorinated or at least one carbon atom is substituted by at least one (CF₃)-group, or an alkyl groups having from 2 to 6 carbon atoms which is substituted by at least by two (CF₃)-groups to form a —C(CF₃)₂— group or by a terminal —C(CF₃)₃ group.

27. The membrane electrode assembly as claimed in claim 19, whereas in alternative (b), R¹, independent of each other, stands for bivalent alkyl groups having from 1 to 10 carbon atoms.

28. The membrane electrode assembly as claimed in claim 19, whereas in alternative (b), R¹, independent of each other, stand for bivalent aromatic groups having 5 to 6 carbon atoms, in which one or more carbon atoms can be replaced by a heteroatom selected from N, O or S.

29. The membrane electrode assembly as claimed in claim 19, whereas bicovalent aromatic or bicovalent heteroaromatic groups Ar¹, Ar², Ar⁵ and Ar⁶, independent of each other, stand for monocyclic, bicyclic, or polycyclic, either condensed or not, aromatic or heteroaromatic ring systems having 5 to 20 carbon atoms, in which one or more carbon atoms can be replaced by N, O or S, and said bicovalent aromatic or bicovalent heteroaromatic groups Ar¹, Ar², Ar⁵, and Ar⁶ can be substituted by further radicals.

30. The membrane electrode assembly as claimed in claim 19, whereas the polymer comprising the recurring units of the general formula (I) has at least 10 recurring units of the general formula (I).

31. The membrane electrode assembly as claimed in claim 19, whereas the polymer comprising the recurring units of the general formula (I) has a weight averaged molecular weight Mw above 10,000 (determined by Gel Permeation Chromatography).

32. The membrane electrode assembly as claimed in claim 19, whereas the polymer comprising the recurring units of the general formula (I) has a number averaged molecular weight Mn above 5,000.

33. The membrane electrode assembly as claimed in claim 19, whereas the polymer comprising the recurring units of the general formula (I) has a solubility of at least 0.5% wt in DMAc at a temperature of 25° C.

34. The membrane electrode assembly as claimed in claim 19, whereas the weight ratio ionomeric material to catalyst material in the catalyst layer is from 100:1 to 1:100.

35. The membrane electrode assembly as claimed in claim 19, whereas the weight ratio ionomeric material to catalyst material in the catalyst layer is from 1:8 to 1:3 and the polymer electrolyte membrane or electrolyte matrices have a proton conductivity of at least 5 mS/cm at a temperature of 120° C.

36. The membrane electrode assembly as claimed in claim 19, whereas the polymer electrolyte membrane or electrolyte matrices have a proton conductivity of at least 1 mS/cm at temperatures of 120° C.

37. An ionomeric material comprises a polymer comprising the recurring units of the general formula (I) 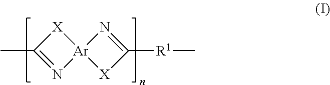
wherein (a)
Ar are identical or different and represent a tetracovalent aromatic group or tetracovalent heteroaromatic group, each can be monocyclic, bicyclic or polycyclic, and
X are identical or different and represent N, O or S and
R¹ are identical or different and represent a bicovalent group of the formula 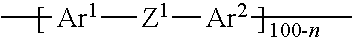
and,
Ar¹ and Ar² are identical or different and represent a bicovalent aromatic group or bicovalent heteroaromatic group, each can be monocyclic, bicyclic or polycyclic, and,
Z¹ are identical or different and represent an bivalent alkyl group and/or an bivalent aromatic group, both in which at least one hydrogen atom is replaced by a fluorine atom, and
n is 0.1 to 99.9 mol-%,
or (b)
Ar are identical or different and represent a tetracovalent group of the formula 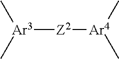
Ar³ and Ar⁴ are identical or different and represent a tricovalent aromatic group or tricovalent heteroaromatic group, each can be monocyclic, bicyclic or polycyclic, and,
Z² are identical or different and represent an bivalent alkyl group and/or an bivalent aromatic group, both in which at least one hydrogen atom is replaced by a fluorine atom, and
X are identical or different and represent N, O or S and
R¹ are identical or different and represent (i) a bicovalent group of the formula 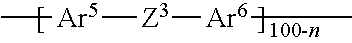
and,
Ar⁵ and Ar⁶ are identical or different and represent a bicovalent aromatic group or bicovalent heteroaromatic group, each can be monocyclic, bicyclic or polycyclic, and,
Z³ are identical or different and represent N, O or S,
or (ii) a bivalent alkyl group and/or an bivalent aromatic group, both of which can be further substituted,
and
n is 0.1 to 99.9 mol-%.

38. A fuel cell comprising at least one membrane electrode assembly as defined in claim 19.
